(19) United States
(12) Patent Application Publication
(10) Pub. No.: US 2012/0233399 A1
(43) Pub. Date: Sep. 13, 2012

(54) STORAGE APPARATUS AND METHOD OF CONTROLLING THE SAME

(76) Inventors: Midori Kurokawa, Odawara (JP); Toshihiro Nitta, Hiratsuka (JP)

(21) Appl. No.: 13/120,346

(22) PCT Filed: Mar. 9, 2011
(86) PCT No.: PCT/JP2011/001377

§ 371 Date: Mar. 22, 2011

(51) Int. Cl. G06F 12/00

(52) U.S. Cl. 711/114; 711/154; 711/E12.001

(57) ABSTRACT

The present invention aims to improve the performance of a storage apparatus.

A controller of a storage apparatus stores therein for each piece of information indicating a communication rate in association with identification of the information piece, and performs speed negotiation for setting a communication rate with an expander upon detecting that coupling to the expander via a communication path has been established. The expander transmits identification information associated with its own maximum communication rate to the controller. The controller acquires the maximum communication rate of the expander on the basis of the identification information, obtains an expected value of the communication rate with the expander on the basis of the maximum communication rate of the expander and the maximum communication rate of the controller, and compares the communication rate set by the speed negotiation with the expected value.

### TECHNICAL FIELD

The present invention relates to a storage apparatus and a method of controlling a storage apparatus.

### BACKGROUND ART

With further progress of computerization of societies, storage apparatuses have been expected to meet increasingly advanced requirements in recent years. To meet such various requirements, new technologies for storage apparatuses have been developed one after another.

For example, a technology has been developed for a computer system including a plurality of SAS (Serial Attached SCSI) target devices, a SAS initiator device, and a switch unit coupled to the SAS target devices through physical links that are physical interconnections and coupled to the SAS initiator device through a wide link including a plurality of physical links. In this computer system, the SAS initiator device controls the number of physical links allocated in the wide link, and to which of the SAS target devices they are linked, and accesses each of the SAS target devices through the physical links thus allocated to the SAS target device while avoiding the physical links not allocated to the SAS target device. With this configuration, this technology aims to minimize as much as possible a decrease in the throughput of the computer system even when accesses are concentrated on a particular one of the SAS target devices (see PTL 1, for example).

### CITATION LIST

### Patent Literature

[PTL 1] Japanese Patent Application Laid-open Publication No. 2007-256993

### SUMMARY OF INVENTION

### Technical Problem

In addition, demands for improving the performance of storage apparatuses have also been increasing. In this regard, the performance of a storage apparatus depends on the performance of controllers coupled to the storage apparatus, the performance of storage drives, the performance of expanders coupling the controllers and the storage drives together, and the rates of communications between them.

The present invention has been made in consideration of these backgrounds, and an objective thereof is to improve the performance of the storage apparatus.

### Solution to Problem

According to a first aspect of the solution of the foregoing problem, there is provided a storage apparatus including a controller that receives a data input/output request transmitted from an information apparatus communicatively coupled to the controller, and transmits an I/O request to a storage drive in response to the data input/output request; and an expander coupled to the controller via a communication path and receives the I/O request transmitted from the controller and transmits the I/O request to the storage drive, wherein the controller includes:

a communication rate table in which each piece of information indicating a communication rate is stored in association with identification information of the piece of information; a controller identification information storage unit that stores controller identification information associated with a maximum communication rate of the controller; a controller communication rate setting unit that sets a communication rate for the expander upon detecting that coupling to the expander via the communication path has been established, by transmitting and receiving test data to and from the expander while changing from a predetermined rate a communication rate in the transmission and reception of the test data; and a controller set value storage unit that stores a set value of the communication rate between the controller and the expander, the expander includes: an expander identification information storage unit that stores expander identification information associated with a maximum communication rate of the expander; and an expander identification information transmission unit that transmits the expander identification information stored in the expander identification information storage unit to the controller, upon detecting that coupling to the controller via the communication path has been established, and the controller includes: an expander identification information receiving unit that receives the expander identification information transmitted from the expander upon detecting that the coupling to the expander via the communication path has been established; a controller maximum communication rate identifying unit that identifies the maximum communication rate of the controller on the basis of the piece of information indicating the communication rate stored in the communication rate table in association with the controller identification information; an expander maximum communication rate identifying unit that identifies the maximum communication rate of the expander on the basis of the piece of information indicating the communication rate stored in the communication rate table in association with the expander identification information; a first expected value calculation unit that obtains a lower one of the maximum communication rate of the controller and the maximum communication rate of the expander as an expected value of the communication rate between the controller and the expander; a first communication rate comparison unit that compares the expected value of the communication rate between the controller and the expander with the set value of the communication rate between the controller and the expander; and a first comparison result storage unit that stores the comparison result obtained by the first communication rate comparison unit.

Other problems and solutions thereto disclosed in the present specification will be made clear by the descriptions in the section of Description of Embodiments, descriptions of the drawings, and the like.

### Advantageous Effects of Invention

According to the present invention, the performance of a storage apparatus can be improved.

### BRIEF DESCRIPTION OF DRAWINGS

FIG. 1 is a diagram showing an overall configuration of a storage system.

FIG. 2 is a diagram showing a configuration of a memory.

FIG. 3 is a diagram showing a configuration of an expander.

FIG. 4 is a diagram showing a configuration of a memory.

FIG. 5 is a diagram showing a configuration of an NVRAM.

FIG. 6 is a diagram showing a SAS address.

FIG. 7 is a diagram showing a routing table.

FIG. 8 is a diagram showing an identify address frame.

FIG. 9 is a diagram showing an IAF management table.

FIG. 10 is a diagram showing an open address frame.

FIG. 11 is a diagram showing a report general response.

FIG. 12 is a diagram showing the report general response.

FIG. 13 is a diagram showing the report general response.

FIG. 14 is a flowchart showing a flow of a discover process.

FIG. 15 is a diagram showing a discover request command.

FIG. 16 is a diagram showing a discover response command.

FIG. 17 is a diagram showing a discover management table.

FIG. 18 is a diagram showing a latest map storage table.

FIG. 19 is a diagram for explaining a connection rate.

FIG. 20 is a diagram for explaining the connection rate.

FIG. 21 is a diagram for explaining the connection rate.

FIG. 22 is a diagram for explaining a communication rate.

FIG. 23 is a diagram for explaining the communication rate.

FIG. 24 is a diagram for explaining the communication rate.

FIG. 25 is a flowchart showing a flow of the discover process.

FIG. 26 is a diagram showing a discover list request command.

FIG. 27 is a diagram showing a discover list response command.

FIG. 28 is a diagram showing the discover list response command.

FIG. 29 is a diagram showing the discover list response command.

FIG. 30 is a diagram showing the discover list response command.

FIG. 31 is a diagram showing the discover list response command.

FIG. 32 is a diagram showing a SAS address identification information management table.

FIG. 33 is a flowchart showing a flow of a link-up process.

FIG. 34 is a flowchart showing the flow of the link-up process.

FIG. 35 is a flowchart showing a flow of the discover process.

FIG. 36 is a flowchart showing the flow of the discover process.

FIG. 37 is a flowchart showing the flow of the discover process.

FIG. 38 is a flowchart showing the flow of the discover process.

FIG. 39 is a flowchart showing the flow of the discover process.

FIG. 40 is a flowchart showing the flow of the discover process.

FIG. 41 is a flowchart showing a flow of a connection rate setting process.

FIG. 42 is a flowchart showing a flow of a RAID group forming process.

FIG. 43 is a diagram showing a discover error management table.

FIG. 44 is a diagram showing an IO error management table.

FIG. 45 is a diagram showing a device management table.

FIG. 46 is a diagram showing a RAID information management table.

FIG. 47 is a flowchart showing a flow of a data write process.

FIG. 48 is a flowchart showing a flow of a data read process.

FIG. 49 is a flowchart showing a flow of a discover process.

### DESCRIPTION OF EMBODIMENTS

Hereinafter, an embodiment will be described with reference to the drawings.

==Overall Configuration==

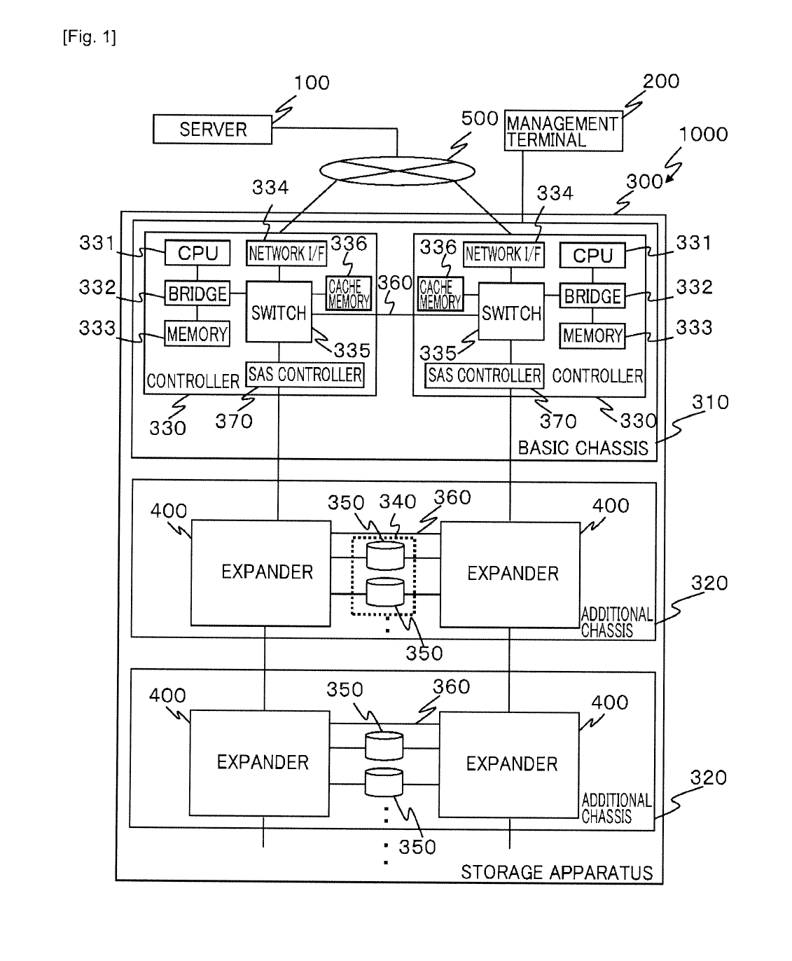

FIG. 1 shows an overall configuration of storage system 1000 of the present embodiment.

As shown in FIG. 1, the storage system 1000 includes at least one server 100, a storage apparatus 300, and a management terminal 200. Note that the server 100 corresponds to an information apparatus described in the section of the Claims.

The server 100 is a computer that provides services such as automated teller services of banks or Internet web page browsing services, for example. The storage apparatus 300 provides a data storage area to application programs and the like executed on the server 100.

The management terminal 200 is a computer that maintains and manages the storage apparatus 300. An operator can perform operations such as forming RAID (Redundant Arrays of Inexpensive Disks) using a plurality of storage drives inside the storage apparatus 300, changing the configuration of RAID (for example, change from RAID 1 to RAID 5), and installing or uninstalling a storage drive 350, for example, by operating the management terminal 200. The operator can set and control these operations through a user interface included in the management terminal 200.

The server 100 and the storage apparatus 300 are communicatively coupled to each other through network 500. The network 500 is implemented by use of SAN (Storage Area Network), for example.

Instead, the network 500 can be implemented by use of a LAN (Local Area Network), a WAN (Wide Area Network), the Internet, a public telecommunication network, a dedicated line, or the like.

Communications through the network 500 are performed in accordance with protocols such as Fibre Channel Protocol, TCP/IP, iSCSI (internet Small Computer System Interface), FICON (Fibre Connection) (registered trademark), ESCON (Enterprise System Connection) (registered trademark), ACONARC (Advanced Connection Architecture) (registered trademark), and FIBARC (Fibre Connection Architecture) (registered trademark).

The server 100 is a computer such as a personal computer, a mainframe, or an office computer. When accessing a storage area provided by the storage apparatus 300, the server 100 sends the storage apparatus 300 a data frame (abbreviated as frame, below) including a data input/output request (a data write request, a data read request or the like).

==Storage Apparatus==

The storage apparatus 300 according to the present embodiment includes a basic chassis 310 having controllers 330 and additional chassis 320 having no controllers 330. The additional chassis 320 is cascaded to the basic chassis 310. The additional chassis 320 includes a storage drive 350 for storing data.

The controller 330 is a device for controlling the storage apparatus 300. The storage apparatus 300 according to the present embodiment redundantly includes two controllers 330 for enhancement of reliability, load balancing and the like of the storage apparatus 300.

Upon receipt of a data input/output request (data write request or data read request) transmitted from the server 100, the controller 330 transmits an I/O request to the storage drive 350 and writes or reads data. Then, the controller 330 sends the server 100 a response concerning the process executed in response to the data input/output request sent from the server 100 (read data, a read completion report, a write completion report, or the like).

<Basic Chassis>

The basic chassis 310 includes the two controllers 330. Each of the controllers 330 includes a communication I/F (InterFace) 334, a switch 335, a cache memory (CM) 336, a bridge 332, a CPU (Central Processing Unit) 331, a memory (LM) 333 and a SAS (Serial Attached SCSI) controller 370.

The controller 330 is formed as a unit, and is installed into and uninstalled from the basic chassis 310 by being inserted and pulled out along an installation slot provided to the basic chassis 310.

The communication I/F 334 performs processes when receiving and transmitting various kinds of commands and data from and to the server 100 via the network 500.

The cache memory 336 stores data to be written to the storage drives 350 by the server 100 or data read from the storage drives 350.

The CPU 331 is a device for controlling the whole of the controller 330. The CPU 331 controls the controller 330 by executing various programs stored in the memory 333 with reference to data, tables and the like stored in the memory 333 and the cache memory 336.

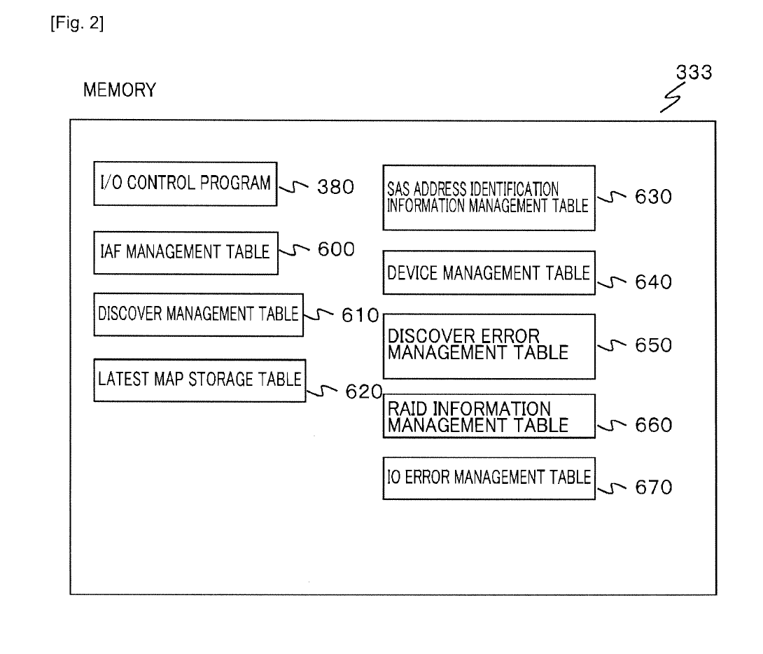

The memory 333 stores the various programs, data, tables and the like for controlling the controller 330. FIG. 2 shows programs and tables stored in the memory 333.

The memory 333 stores I/O control program 380, routing table 421, IAF (Identify Address Frame) management table 600, discover management table 610, a latest map storage table 620, SAS address identification information management table 630, device management table 640, discover error management table 650, RAID information management table 660, and IO error management table 670, which will be described in detail later.

The I/O control program 380 is stored in the storage drive 350 and is loaded into the memory 333 when the CPU 331 executes the I/O control program 380. Various functions of the storage apparatus 300 according to the present embodiment are implemented by the CPU 331 executing the I/O control program 380.

For example, the CPU 331 executes the I/O control program 380 to form a RAID by using a plurality of storage drives 350 included in the storage apparatus 300, to write and read data to and from the storage drives 350 forming the RAID in response to data input/output requests transmitted from the server 100, and to transmit responses concerning the processes executed in response to the data input/output requests to the server 100.

In addition, the CPU 331 executes the I/O control program 380 to perform operations such as creating new RAID, changing the configuration of an already created RAID, and cancelling the RAID in response to commands transmitted from the management terminal 200.

Moreover, the CPU 331 executes the I/O control program 380 to control the SAS controller 370. The SAS controller 370 performs a discover process on each of the expanders 400 and the storage drives 350 included in the storage apparatus 300. The discover process will be explained later.

Further, though details will be described later, the CPU 331 executes the I/O control program 380 to control the expanders 400 configured to relay various commands transmitted from the server 100 to the storage drives 350. Under the control of the CPU 331, each of the expanders 400 creates the routing table 421 for transferring commands to appropriate paths.

Furthermore, the CPU 331 executes the I/O control program 380 to perform operations such as detecting various errors caused in the SAS controllers 370, the expanders 400 and the storage drives 350, identifying factors causing the errors, performing error recovery processes, and sending notifications to the management terminal 200.

Needless to say, at least part of the functions of the storage apparatus 300 according to this embodiment may be implemented by hardware logic.

Returning to FIG. 1, the bridge 332 couples the CPU 331, the memory 333 and the switch 335 to each other.

The switch 335 is a switch compatible with a standard such as PCI express (PCI: Peripheral Component Interconnect), and couples the communication I/F 334, the cache memory 336, the SAS controller 370, and the bridge 332 to each other. In addition, the switch 335 is coupled via an internal bus 360 to the switch 335 in the other controller 330 included for redundancy.

The SAS controller 370 is compatible with the SAS standard, and exchanges data and commands with the expanders 400 and the storage drives 350 in accordance with SSP (Serial SCSI Protocol), STP (Serial ATA Tunneled Protocol) or SMP (Serial Management Protocol) protocols under the control of the CPU 331. In addition, the SAS controller 370 includes PHYs 411, and exchanges data and commands with the expanders 400 and the storage drives 350 via the PHYs 411, which will be described in detail later.

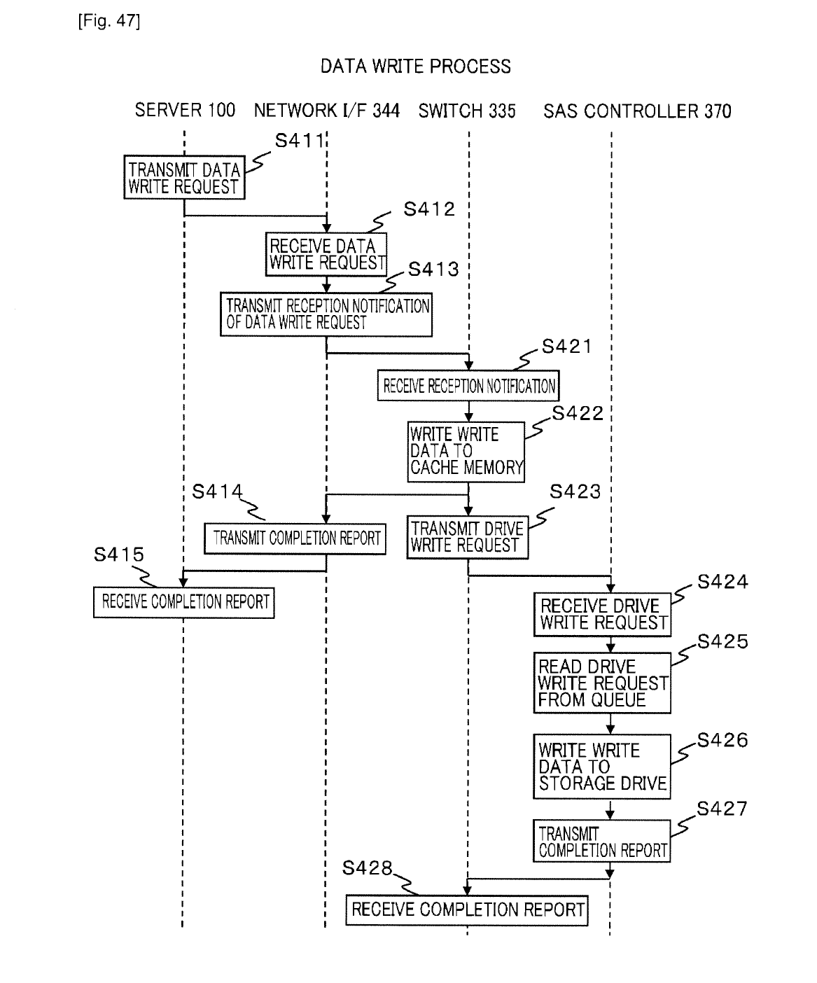

FIG. 47 is a diagram for explaining a basic operation of the storage apparatus 300, that is, a flowchart illustrating a process executed when the storage apparatus 300 receives a frame including a data write request from the server 100 (this process is also called data write process, below). Hereinbelow, the data write process will be explained with reference to FIG. 47. Incidentally, in the following description, the letter “S” attached before the numerals indicates step.

A frame transmitted from the server 100 is firstly received by the communication I/F 334 of the storage apparatus 300 (S411, S412). Upon receiving the frame, the communication I/F 334 notifies the switch 335 that the frame has been received (S413).

Upon receiving the notification from the communication I/F 334 (S421), the switch 335 generates a drive write request based on the data write request of the frame, and stores write data in the cache memory 336 (S422).

Then, the switch 335 transmits the generated drive write request to the SAS controller 370 (S423). The communication I/F 334 transmits a completion report to the server 100 (S414), and the server 10 receives the completion report (S415).

Upon receiving the drive write request, the SAS controller 370 registers the received drive write request into a write process waiting queue not illustrated (S424). The SAS controller 370 reads the drive write request from the write process waiting queue as needed (S425). The SAS controller 370 reads write data specified in the read drive write request from the cache memory 336, and writes the read write data to the storage drive 350 (S426).

Next, the SAS controller 370 notifies the switch 335 of a report (completion report) that writing of the drive write data in response to the drive write request has been completed (S427). The switch 335 receives the transmitted completion report (S428).

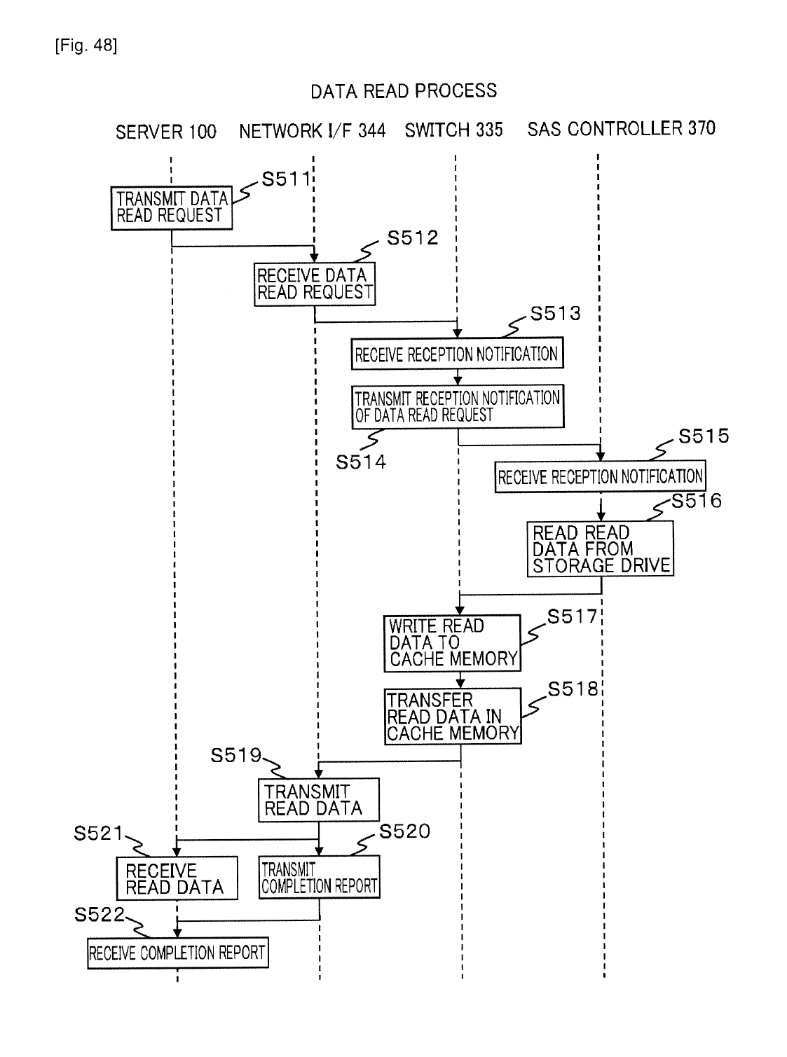

FIG. 48 is a diagram for explaining a basic operation of the storage apparatus 300, that is, a flowchart illustrating an I/O process performed when the storage apparatus 300 receives a frame including a data read request from the server 100 (this process is also called a data read process below). Hereinafter, the data read process will be explained with reference to FIG. 48.

A frame transmitted from the server 100 is received by the communication I/F 334 of the storage apparatus 300 (S511, S512). Upon receiving the frame from the server 100, the communication I/F 334 notifies the switch 335 that the frame has been received (S513). Upon receiving the notification that the frame has been received, the switch 335 notifies the SAS controller 370 that the frame has been received (S514).

Upon receiving the notification from the switch 335 (S515), the SAS controller 370 reads data specified in the data read request included in the frame (for example, specified by a LBA (Logical Block Address)) from the storage drive 350 (S516).

Here, if the read data exists in the cache memory 336 (in a case of a cache hit), the read process from the storage drive 350 (S516) is usually omitted.

The switch 335 writes the data read by the SAS controller 370 to the cache memory 336 (S517). The switch 335 transfers the data written to the cache memory 336 to the communication I/F 334 as needed (S518).

The communication I/F 334 sequentially transmits the read data transmitted from the switch 335 to the server 100 (S519). When transmission of the read data is completed, the communication I/F 334 transmits a completion report to the server 100 (S520). The server 100 receives the transmitted completion report (S521, S522).

Incidentally, all or part of the storage areas for the cache memories 336 and the memories 333 is shared by the two controllers 330. When one of the two controllers 330 has a failure or is overloaded, the other controller 330 takes over information held in the failed controller 330. Thus, the two controllers 330 can implement failover or load balancing.

In the course of activating the storage apparatus 300 or installing a new additional chassis 320 in the storage apparatus 300, for example, the controller 330 performs the discover process, which will be described in detail later.

<Additional Chassis>

The additional chassis 320 includes the expanders 400 and the storage drives 350. The expanders 400 are redundantly included for enhancement of the reliability, load balancing and the like of the storage apparatus 300.

Each of the storage drives 350 included in the additional chassis 320 is coupled to the controllers 330 via the expanders 400.

Each of the expanders 400 functions as a relay apparatus for enabling communications (Interconnect) between the SAS controller 370 and the storage drives 350. For example, the expander 400 performs routing control of various commands such as I/O requests transmitted from the SAS controller 370 to the other expanders 400 and the storage drives 350.

In addition, the expander 400 includes PHYs 411, and transmits and receives data and commands via the PHYs 411 to and from the SAS controller 370 and the storage drives 350, which will be described in detail later.

When the controller 330 performs the discover process in the course of booting the storage apparatus 300 or installing a new additional chassis 320 in the storage apparatus 300, for example, the expander 400 sends the SAS controller 370 information on a device coupled to each of its own PHYs 441 in response to a discover command sent from the SAS controller 370.

The expander 400 functions as an initiator or a target in protocols such as SMP (Serial Management Protocol), SSP (Serial SCSI Protocol) and STP (Serial ATA tunneling Protocol). In addition, the expander 400 constitutes a tree-type network topology including the SAS controller 370, for example, as a starting point (root).

In the following description for a path from the SAS controller 370 to each storage drive 350 via the expander 400, an upstream side indicates a side closer to the SAS controller 370 along the path and a downstream side indicates a side closer to the storage drive 350 along the path.

Other details of the expander 400 will be described later.

The storage drive 350 is a hard disk drive or a semiconductor storage device (Solid State Drive (SSD)) compatible with a standard such as SAS and SATA (Serial ATA), for example. The storage drive 350 includes a PHY 411, and exchanges data between the PHY 411 in the expander 400 coupled to the storage drive 350 and the PHY 411 in the storage drive 350.

A RAID group 340 is formed by using these multiple storage drives 350. Each storage drive 350 forming the RAID group 340 is provided with a logical volume (also called a LU (logical unit) below). A storage drive 350 not forming the RAID group 340 is used as a spare drive which is an alternative to a storage drive 350 having a failure, for example.

The logical volumes formed in the RAID group 340 are discriminated from each other on the basis of LUNs (Logical Unit Numbers). The LUN is set in the data input/output request sent from the server 100 to the storage apparatus 300, for example.

Incidentally, the expanders 400 and the storage drives 350 may also be included not only in the additional chassis 320 but also in the basic chassis 310. In this case, the storage apparatus 300 may have a configuration not including the additional chassis 320.

In addition, the storage apparatus 300 may have a configuration including the controllers 330 and the expanders 400 but not including the storage drives 350. In this configuration, the storage apparatus 300 is coupled to each of the storage drives 350 via a communication path.

In the following description, “device” is used as a collective term indicating any of the SAS controllers 370, the expanders 400, and the storage drives 350.

==Expander==

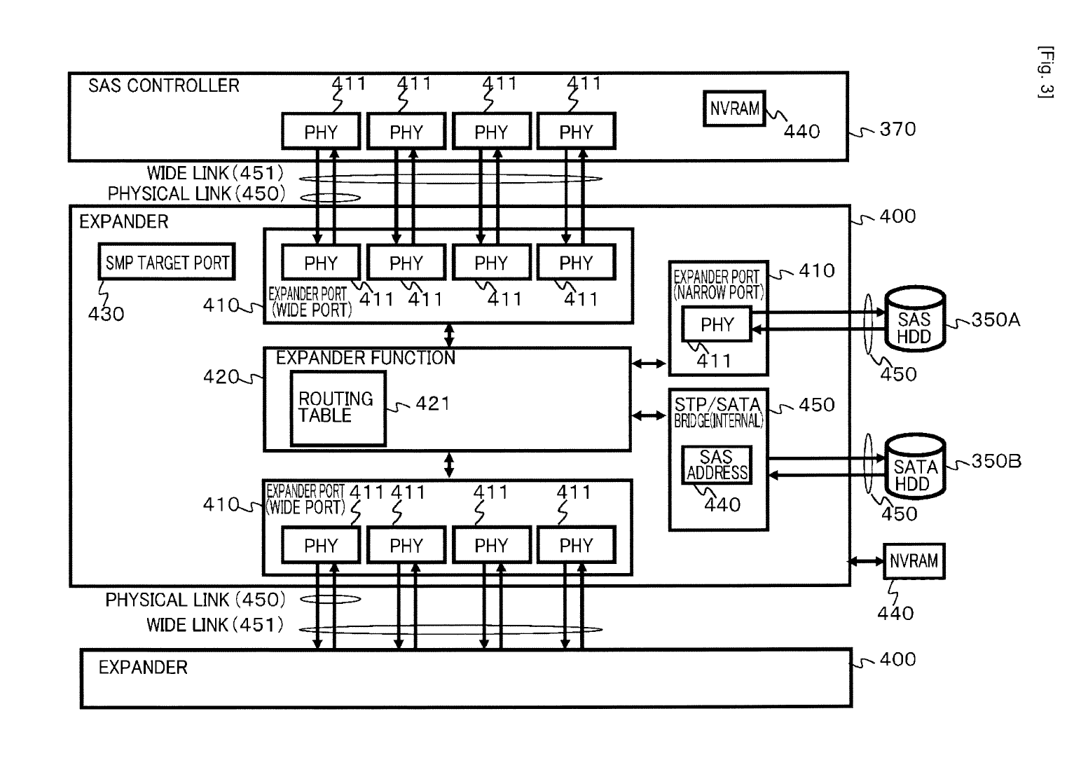

The expander 400 functions as a switch or router that relays communications preformed between the SAS controller 370 and the storage drives 350. FIG. 3 shows a configuration example of the expander 400.

The expander 400 includes expander ports 410, expander function 420, SMP target port 430 and STP/SATA bridge 450. In addition, the expander 400 is coupled to NVRAM 440 via a local path such as an I2C (Inter-Integrated Circuit)

<Expander Port>

Each of the expander ports 410 includes one or more PHYs 411. The PHY 411 is a communication port coupled to a physical link 450. The physical link 450 is formed with a cable, a connector or the like which serves as a data communication path.

The expander 400 is communicatively coupled to devices such as SAS controllers 370, other expanders 400, and storage drives 350 via the physical links 450 coupled to the PHYs 411.

Here, the expander 400 can be configured to communicate with any of the SAS controllers 370, the other expanders 400, and the storage drives 350 by controlling a plurality of physical links 450 as a single logical communication path (wide link 451). In the example shown in FIG. 3, four physical links 450 between the SAS controller 370 and the expander 400 are formed as a single wide link 451.

Note that each PHY 411 includes a memory 412 for storing various data therein. Each memory 412 stores an identifier (also called a PHY ID below) in advance (for example, during manufacturing), and the identifier is for uniquely identifying each PHY 411.

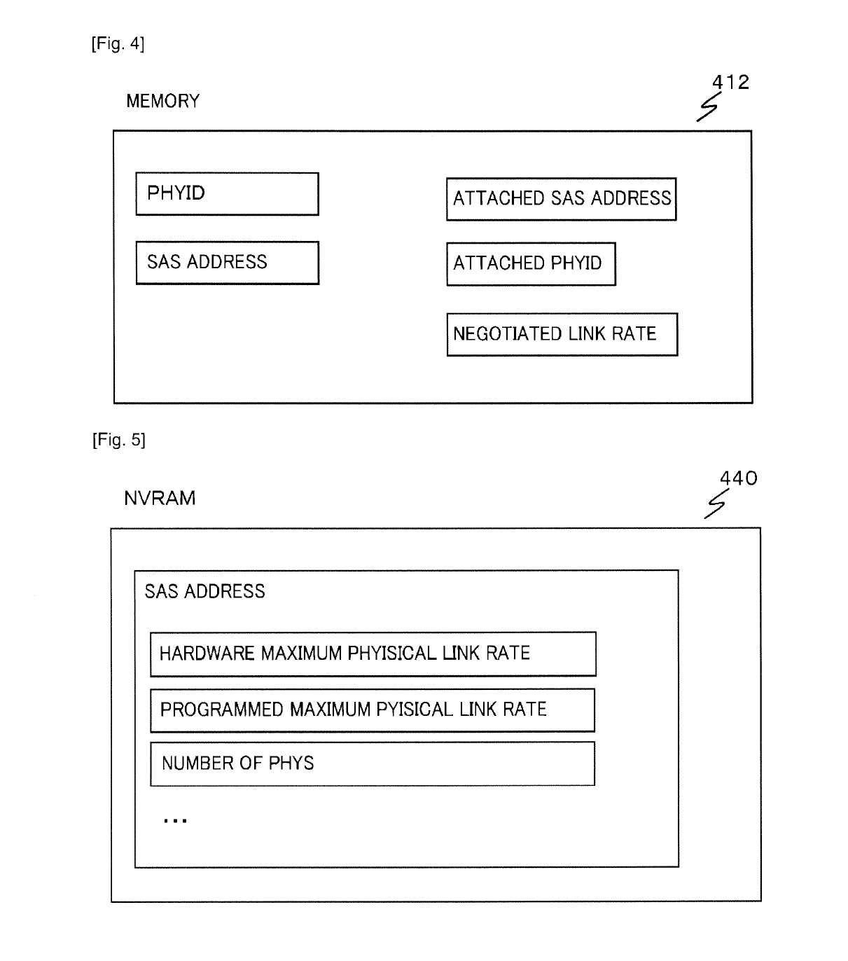

FIG. 4 shows an example of the memory 412 included in the PHY 411. In addition, the SAS address assigned to a device equipped with the PHY 411 may be stored in the NVRAM 440 during manufacturing, for example.

In addition, upon detecting that coupling to a PHY 411 of another device via a physical link 450 is established, the PHY 411 executes a link-up sequence process and acquires the PHY ID of the coupled PHY 411 (also called an ATTACHED PHY ID, below) and the SAS address of the coupled device (also called an ATTACHED SAS ADDRESS, below). The memory 412 also stores the ATTACHED PHY ID and the ATTACHED SAS ADDRESS. This will be described in detail later.

Moreover, the memory 412 also stores a set value of a communication rate (also called a negotiated link rate, below) determined through a speed negotiation process performed by the PHY 411 with the coupled PHY 411 in the link-up sequence process.

Here, the expander port 410 including the PHYs 411 coupled to the wide link 451 is also called a wide port, whereas the expander port 410 including the PHY 411 not coupled to the wide link 451 is also called a narrow port

<STP/SATA Bridge>

Returning to FIG. 3, the STP/SATA bridge 450 performs conversion between the SATA standard and the SAS standard, and thereby allows the storage drive 350B compatible with the SATA standard to be coupled to the expander 400.

<NVRAM>

The NVRAM 440 stores data such as the SAS address assigned to each of devices compatible with the SAS standard (the SAS controllers 370, the expanders 400, and the storage drives 350) in advance (for example, during manufacturing). FIG. 5 shows an example of the NVRAM 440.

The NVRAM 440 stores the SAS address assigned to the device including the NVRAM 440. The SAS address is an identifier for uniquely identifying each device compatible with the SAS standard. Moreover, although described in detail later, since the SAS address according to the present embodiment has a specification ID written therein, when a SAS address is identified, a maximum communication rate determined based on the hardware performance achievable by the device in communications with other devices (also called a hardware physical link rate or HARDWARE MAXIMUM PHYSICAL LINK RATE, below); a maximum communication rate determined as a maximum communication rate practicable in actual operation (also called a programmed physical link rate or PROGRAMMED MAXIMUM PHYSICAL LINK RATE, below); and the number of PHYs 411 (PHY number) included in the device can be identified.

Note that, the hardware physical link rate and the programmed physical link rate, and the PHY number can be kept stored in the NVRAM 440 together with the SAS address.

Even when the hardware physical link rate of a particular device is set to 6 Gbps, for example, the maximum communication rate of the particular device is 3 Gbps if the programmed physical link rate is set to 3 Gbps. If the programmed physical link rate of this device is updated to 6 Gbps, this device can communicate at 6 Gbps. However, even when the programmed physical link rate of this device is updated to 12 Gbps, this device can communicate at 6 Gbps at most.

In short, the maximum communication rate of the device is the lower one of the programmed physical link rate and the hardware physical link rate.

Note that, the communication rate of communications performed between this device and another device coupled to this device is the lower one of the maximum communication rate of the coupled device and the maximum communication rate of the this device itself (also called a expected communication rate or an expected value of the communication rate, below).

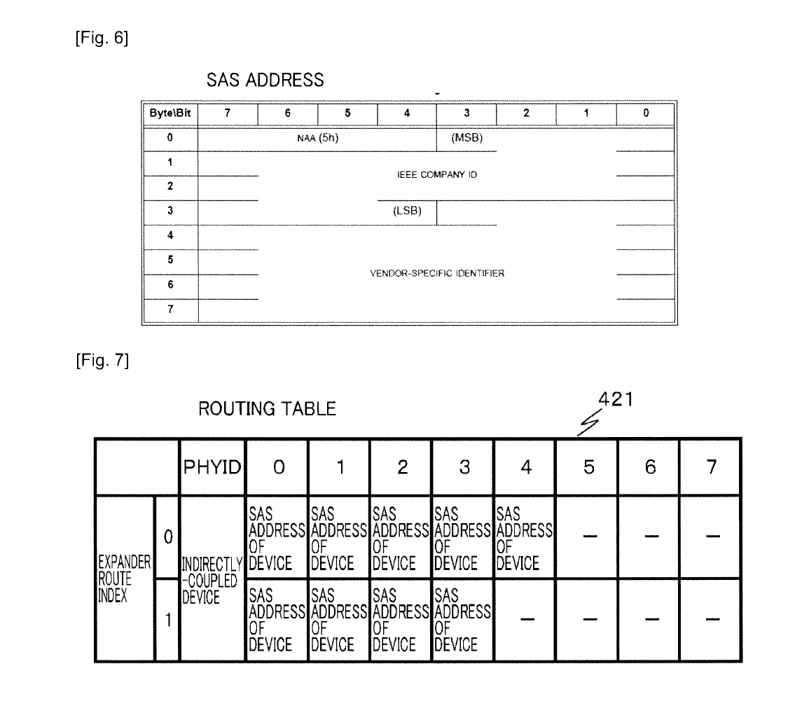

FIG. 6 shows a SAS address data format. The SAS address data format is defined in the SAS standard. The SAS address includes an IEEE COMPANY ID field and a VENDER-SPECIFIC ID field as shown in FIG. 6.

The IEEE COMPANY ID field has written therein an ID for uniquely identifying a manufacturer of a device. The VENDER-SPECIFIC ID field has written therein information with which the manufacturer uniquely identifies each device. For example, a serial number or the like is written. For the devices in the present embodiment, a specification ID indicating a specification of each device is written in the VENDOR-SPECIFIC ID field, which will be described in detail later. Note that, the specification ID is equivalent to controller identification information, expander identification information, and storage drive identification information described in the section of the Claims.

When identifying the specification ID of a device such as expander 400, the controller 330 can obtain information on the device, such as the hardware physical link rate, the programmed physical link rate, the number of PHYs 411, and the SAS standard supported by the device. This will be described in detail later.

Since the IEEE COMPANY ID field of the SAS address includes description of the ID for uniquely identifying a manufacturer of each device, the information written in the VENDOR-SPECIFIC ID field can be updated even after the device starts to be used, for example, as long as the information written in the VENDOR-SPECIFIC ID field is unique to the manufacturer of the device.

<Expander Function>

Returning to FIG. 3, the expander function 420 includes the routing table 421, and performs routing control of data and commands exchanged with the SAS controllers 370 and the storage drives 350 with reference to the routing table 421.

FIG. 7 shows an example of the routing table 421. In the routing table 421, the expander route index and the SAS address of an indirectly-coupled device are written for each PHY 411.

Upon receiving a command addressed to one of the storage drives 350 from the SAS controller 370, for example, the expander function 420 can determine which PHY 411 to use for outputting the command by referring to the routing table 421 using as a key the SAS address indicating the addressed device written in the command.

Here, in an indirectly-coupled device field of the routing table 421, there are written SAS addresses of all the devices possible of being destinations of commands received from other devices.

The SAS controllers 370 and each of the expanders 400 inside the storage apparatus 300 store their own specific routing tables 421. These routing tables 421 are created or updated when the controller 330 in the storage apparatus 300 performs the discover process in the course of activating the storage apparatus 300 or connecting a new additional chassis 320 in the storage apparatus 300, for example.

<SMP Target Port>

Returning to FIG. 3, the SMP target port 430 functions as a target in a case of receiving a command compatible with the SMP standard from the SAS controller 370. In this case, the SAS controller 370 functions as an initiator.

Not only the expander 400, but also other devices compatible with the SAS standard, that is, the SAS controllers 370 and the storage drives 350 also include the aforementioned expander ports 410 and SMP target port 430.

==Link-Up Sequence Process==

Next, description will be given for the link-up sequence process performed upon direct coupling of a device such as the SAS controller 370, the expander 400, or the storage drive 350 to another device via a physical link 450.

All the devices compatible with the SAS standard (the SAS controllers 370, the expanders 400, and the storage drives 350) include the PHYs 411 as physical ports. Each of the PHYs 411 includes a circuit and the like that are controlled by a hardware logic or a micro program to execute the link-up sequence process upon detecting that coupling of the PHY 411 to another device through a physical link 450 has been established.

The link-up sequence process includes the speed negotiation process and an identify address frame exchange process.

<Speed Negotiation>

Once a device such as the expander 400 is directly coupled to another device via a physical link 450, the PHY 411 makes a speed negotiation with the PHY 411 coupled to the PHY 411 through the physical link 450.

The speed negotiation is a process in which the PHYs 411 directly coupled to each other via the physical link 450 determines their communication rate by transmitting and receiving predetermined test data while changing the communication rate from a predetermined rate.

When the communication rate is determined, each of the PHYs 411 stores the determined communication rate (negotiated link rate) in the memory 412 included in the PHY 411. After the communication rate is determined, each of the PHYs 411 exchanges data and the like at the determined communication rate when communicating with the coupled PHY 411.

The communication rate of SAS1 which is one version of the SAS standard is 1.5 Gbps or 3 Gbps. SAS2 standard supports 6 Gbps additionally. In the future, higher communication rates, such as 12 Gbps, 18 Gbps and 24 Gbps, for example, are assumed to be supported.

<Exchange of Identify Address Frames>

After the communication rate is determined, each PHY 411 sends the coupled PHY 411 an identify address frame in which the PHY ID set for the PHY 411 itself and the SAS address of the device including the PHY 411 itself are written. Its own PHY ID and the SAS address are stored in the memory 412 of each PHY 411 upon booting. Note that if the SAS address is not stored in the memory 412, each PHY 411 may acquire the SAS address from the NVRAM 440 and transmit the SAS address to the coupled PHY 411.

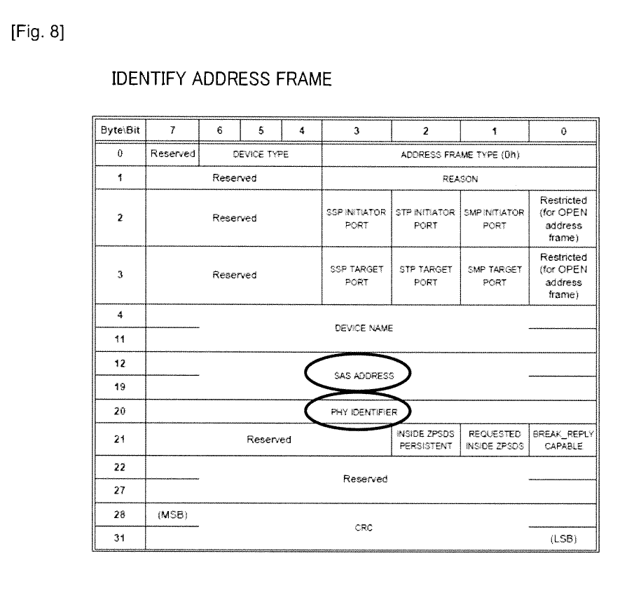

FIG. 8 shows an identify address frame transmitted by the PHY 411. The PHY 411 acquires the PHY ID (ATTACHED PHY ID) of the PHY 411 directly coupled to the PHY 411 itself via the physical link 450, and the SAS address of the coupled device (directly-coupled device) (ATTACHED SAS ADDRESS) by exchanging the identify address frame with the coupled PHY 441.

Each PHY 411 stores the PHY ID and the SAS address acquired from the coupled PHY 411 in its own memory 412.

In this way, the directly-coupled devices perform the link-up sequence process together.

Thus, the controller 330 acquires the SAS address of the expander 400 directly coupled to each PHY 411 in its own SAS controller 370, and the PHY ID of the PHY 411 in the expander 400.

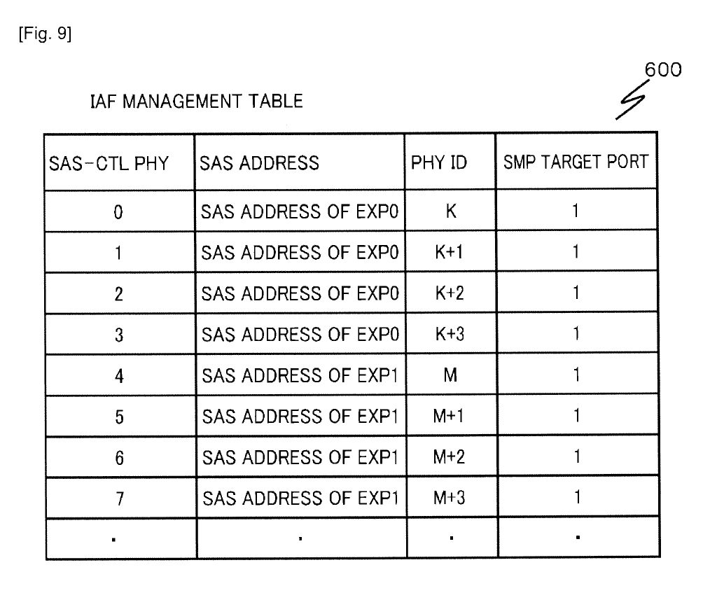

The controller 330 stores these kinds of information in the IAF management table 600 held in the memory 333. FIG. 9 shows an example of the IAF management table 600.

The PHY ID of each PHY 411 in the SAS controller 370 is stored in a SAS-CTL PHY field. The SAS address (ATTACHED SAS ADDRESS) of the expander 400 directly coupled to each PHY 411 in the SAS controller 370 is stored in a SAS ADDRESS field. The PHY ID (ATTACHED PHY ID) of the PHY 411 directly coupled to each PHY 411 in the SAS controller 370 is stored in a PHY ID field. In an SMP TARGET PORT field, stored is whether or not the expander 400 directly coupled to each PHY 411 in the SAS controller 370 includes a function as a SMP target. This information can be also acquired from the coupled device when the identify address frames are exchanged.

==Discover Process==

Hereinafter, description will be provided for processing in which the SAS controller 370 performs as the initiator the discover process on the expander 400.

<Report General>

In the discover process, the SAS controller 370 firstly transmits a report general command to a discover target expander 400 in accordance with the SAS standard in response to an instruction from the CPU 331. The report general command inquires about the number of PHYs 411 included in the expander 400. The discover target expander 400 is an expander 400 directly coupled to the SAS controller 370, at first.

For transmitting the report general command, the SAS controller 370 firstly establishes a connection with the discover target expander 400. Here, the SAS controller 370 can acquire the SAS address of the target expander 400 to be discovered first with reference to the IAF management table 600.

In order to establish the connection with the discover target expander 400, the SAS controller 370 transmits an open address frame to the expander 400 while designating the SAS address of the expander 400 in accordance with the SAS standard.

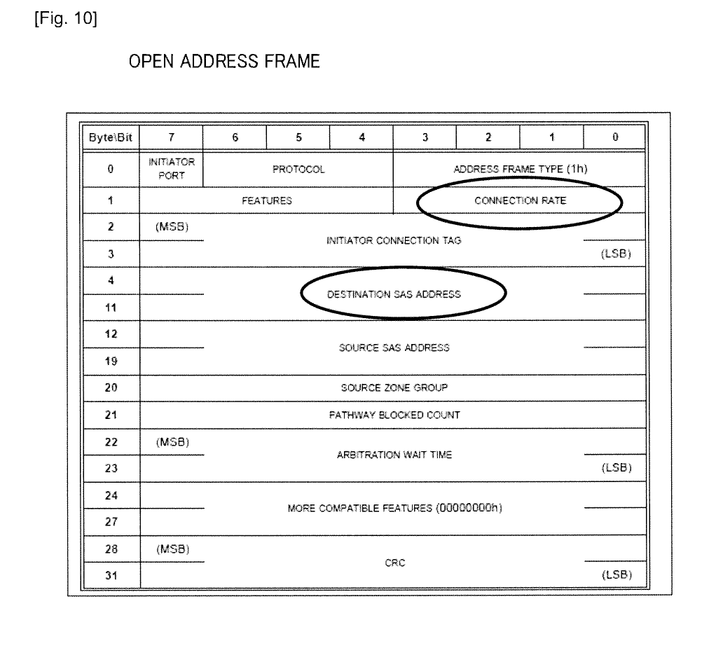

FIG. 10 shows the open address frame transmitted from the SAS controller 370. As shown in FIG. 10, the SAS address and a connection rate of the target device are written in the open address frame. Description on the connection rate will be given later. The controller 330 acquires the information to be written in the open address frame, with reference to the device management table 640.

FIG. 45 shows the device management table 640. The SAS address, the connection rate, a device type and the like of each device possible of being the destination of a command transmitted from the SAS controller 370 are written in the device management table 640.

The open address frame transmitted from the SAS controller 370 is received by the SMP target port 430 in the discover target expander 400.

When the SAS controller 370 receives an open accept from the expander 400, a connection between the SAS controller 370 and the expander 400 is established. Using this connection, the SAS controller 370 can transmit a report general command to the expander 400.

Then, the SAS controller 370 transmits the report general command to the expander 400 with which the connection is established.

Upon receiving this report general command, the SMP target port 430 in the expander 400 transmits a report general response to the SAS controller 370. In the report general response, the number of PHYs 411 included in the expander 400 is written.

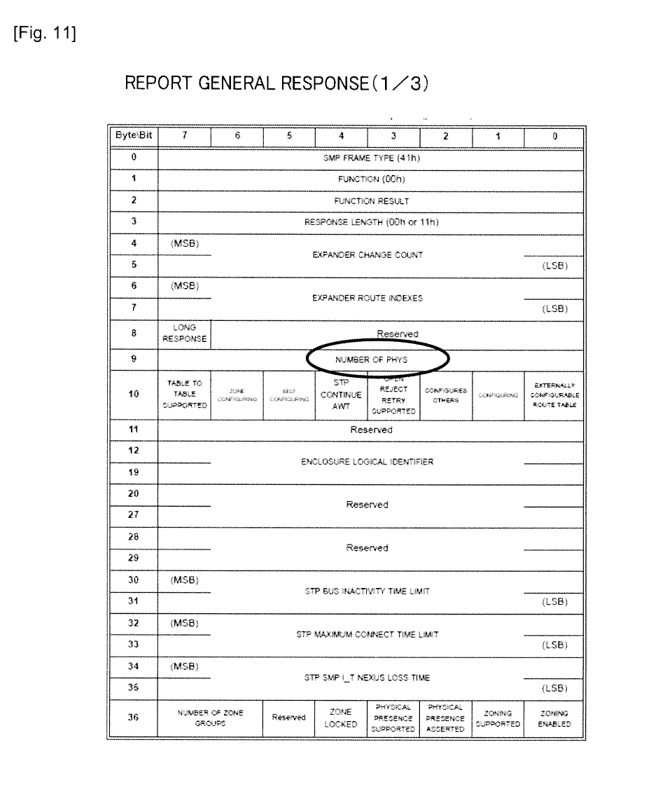

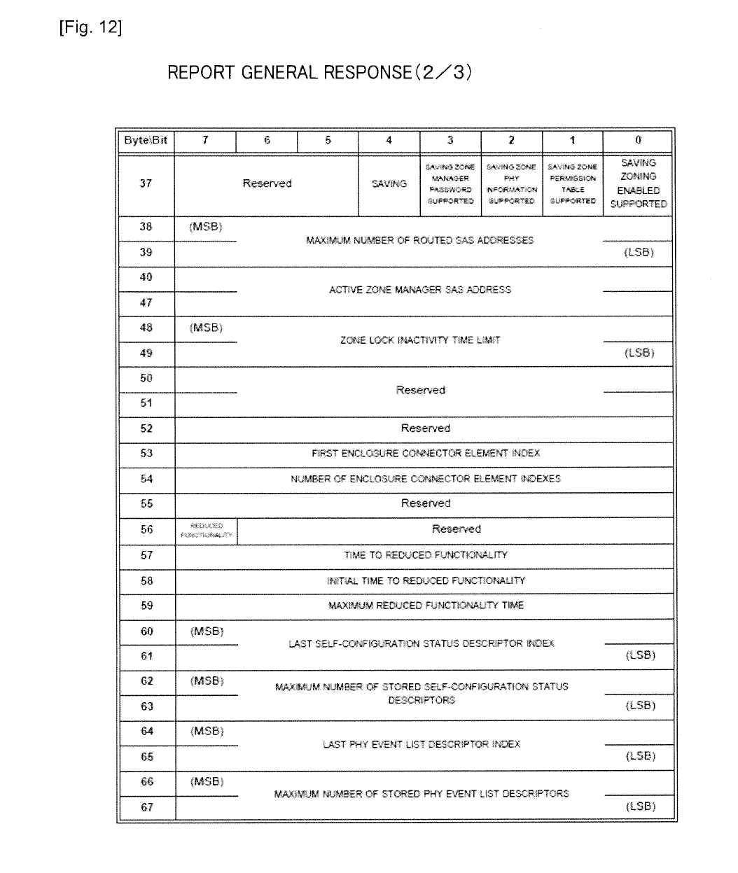

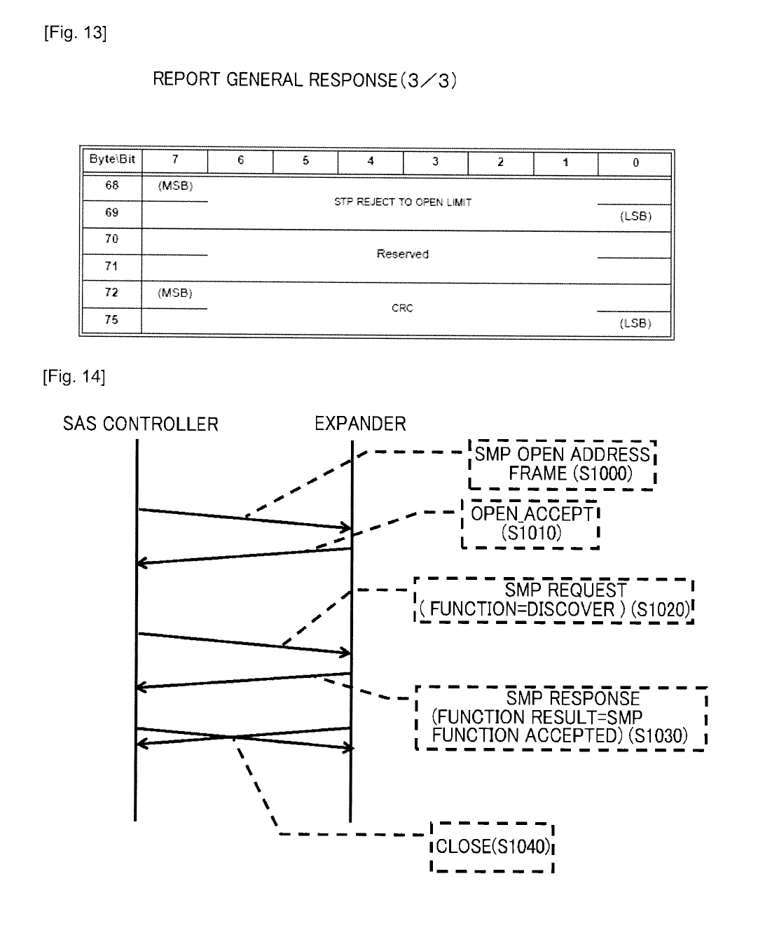

FIGS. 11 to 13 show the report general response.

Upon receiving the report general response from the expander 400, the SAS controller 370 closes the connection with the expander 400. Similarly, the expander 400 also closes the connection with the SAS controller 370.

In this way, the SAS controller 370 acquires the number of PHYs 411 included in the discover target expander 400.

<Discover Process>

Next, the controller 330 performs the discover process on the discover target expander 400. Description on the discover process will be given with reference to the flowchart in FIG. 14.

In the first place, the SAS controller 370 establishes the connection with a discover target expander 400 in response to an instruction from the CPU 331. Here, the SAS controller 370 can acquire the SAS address of the expander 400 to discover first with reference to the IAF management table 600. Specifically, the target expander 400 to discover first is an expander 400 directly coupled to the controller 330.

In order to establish the connection with the discover target expander 400, the SAS controller 370 transmits the open address frame to the expander 400 while designating the SAS address of the expander 400 in accordance with the SAS standard (S1000). The open address frame is received by the SMP target port 430 in the discover target expander 400.

When the SAS controller 370 receives the open accept from the expander 400 (S1010), the connection between the SAS controller 370 and the expander 400 is established. With this, the SAS controller 370 can perform the discover process on the expander 400.

Then, the SAS controller 370 transmits an SMP request to the expander 400 with which the connection is established (S1020). In the SMP request, “discover request” is designated as an argument.

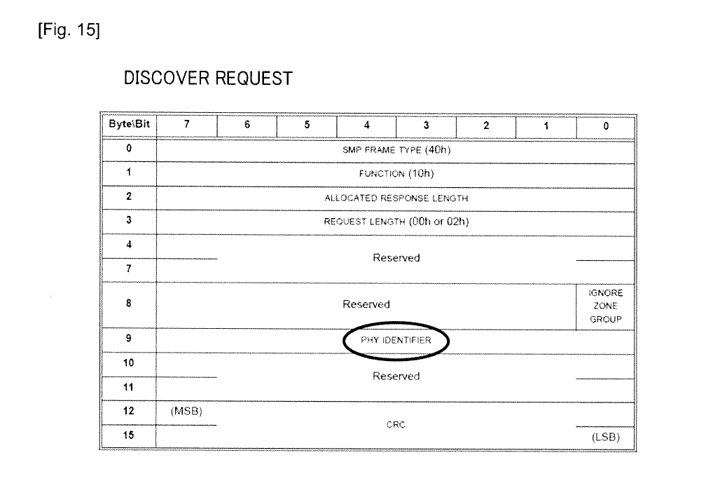

FIG. 15 shows a content of the discover request. The discover request includes a PHY IDENTIFIER field.

The SAS controller 370 writes the PHY ID in this PHY IDENTIFIER field, and then transmits the above SMP request to the expander 400.

Upon receiving the SMP request, the SMP target port 430 in the expander 400 acquires, for the PHY 411 identified by use of the PHY ID written in the PHY IDENTIFIER field, the SAS address (ATTACHED SAS ADDRESS), the ATTACHED PHY ID, and the NEGOTIATED LINK RATE of a device directly coupled to the identified PHY 411. These information are acquired by the PHY 411 itself from the directly-coupled device in the aforementioned link-up sequence process, and are stored in the memory 412 included in the PHY 411.

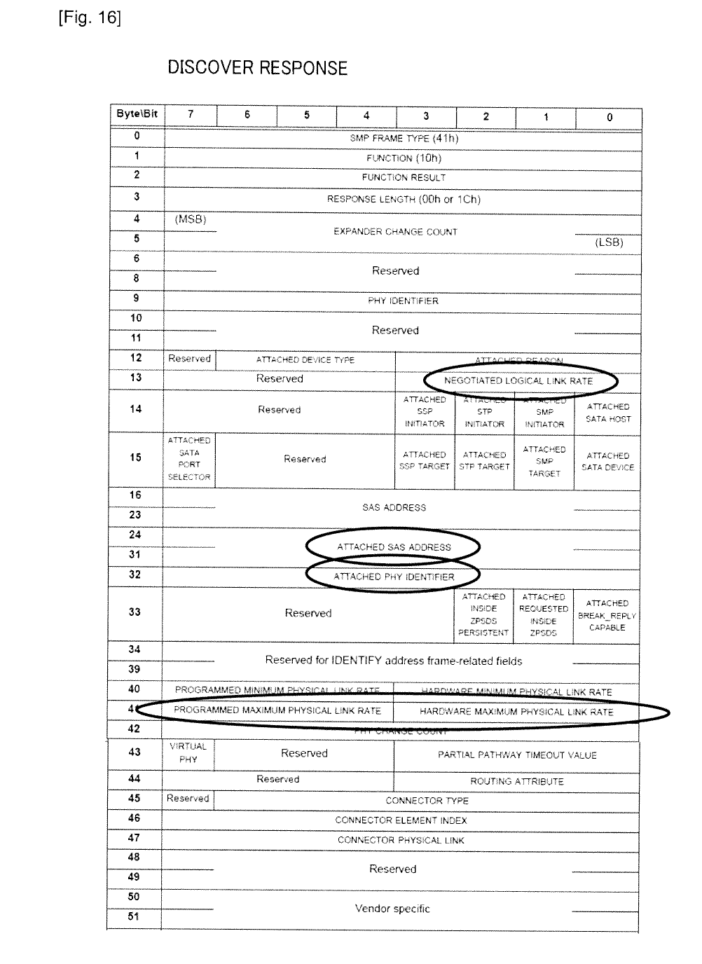

The SMP target port 430 writes these information acquired from the PHY 411 into ATTACHED SAS ADDRESS field, ATTACHED PHY ID field and NEGOTIATED LOGICAL LINK RATE field in the discover response shown in FIG. 16, and transmits the discover response to the SAS controller 370 (S1030).

Upon receiving the discover response from the expander 400, the SAS controller 370 closes the connection with the expander 400 (S1040). Similarly, the expander 400 also closes the connection with the SAS controller 370 (S1040).

The SAS controller 370 performs the above process on all PHYs 411 in the discover target expander 400.

Here, since the controller 330 performs the report general process and acquires the number of PHYs 411 in the discover target expander 400 before starting the discover process, the SAS controller 370 can determine whether or not the discover process is completed for all the PHYs 411 in the discover target expander 400.

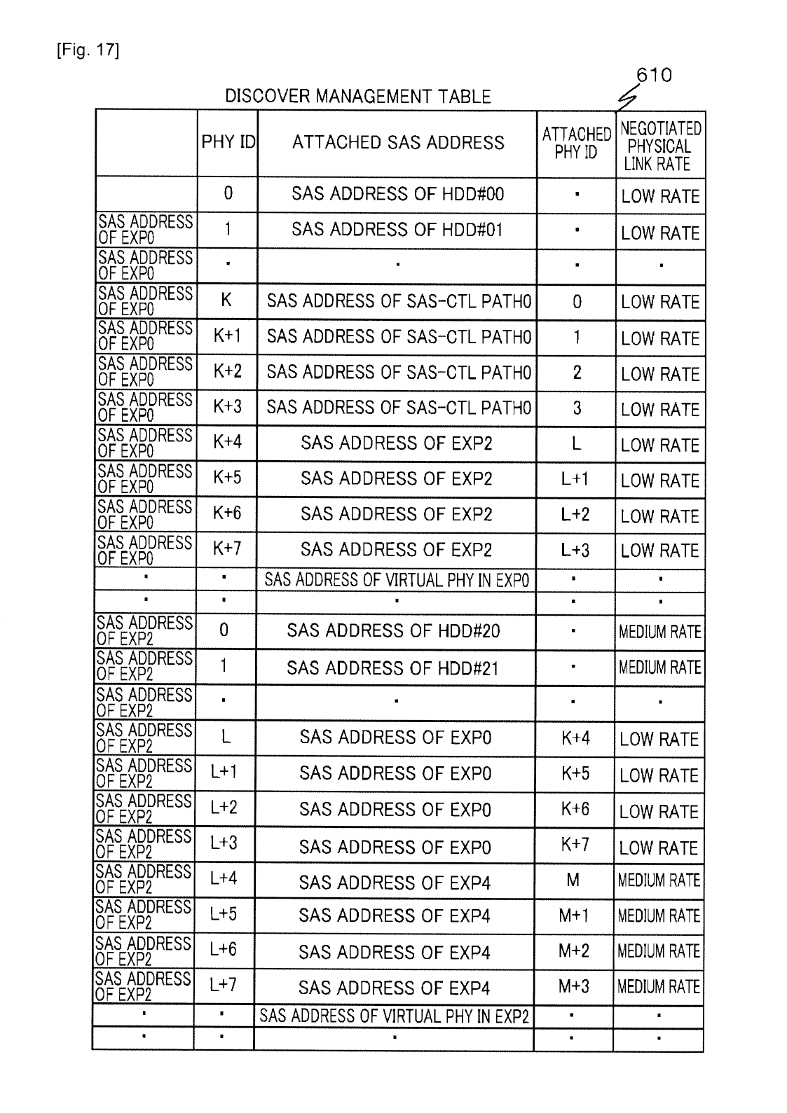

Every time information is acquired from the expander 400 through the discover process, the controller 330 stores the acquired information in the discover management table 610. FIG. 17 shows an example of the discover management table 610.

The SAS address of the discover target device is stored in an EXP SAS ADDRESS field. The PHY ID of each PHY 411 in the discover target device is stored in a PHY ID field. The SAS address of another device directly coupled to the above PHY 411 is stored in an ATTACHED SAS ADDRESS field. The set value of the communication rate (negotiated link rate) determined by the PHY 411 and the coupled PHY 411 in the speed negotiation process is stored in a NEGOTIATED PHYSICAL LINK RATE field.

Thus, by performing the discover process on the discover target expander 400, the SAS controller 370 newly acquires the SAS address (ATTACHED SAS ADDRESS) of another device (the expander 400 or the storage drive 350) directly coupled to the discover target expander 400.

Then, the controller 330 performs the discover process targeted for a new device. By sequentially executing the discover process on all the devices in the same manner, the controller 330 can complete the execution of the discover process on all the devices in the storage apparatus 300 and can acquire information on all the devices.

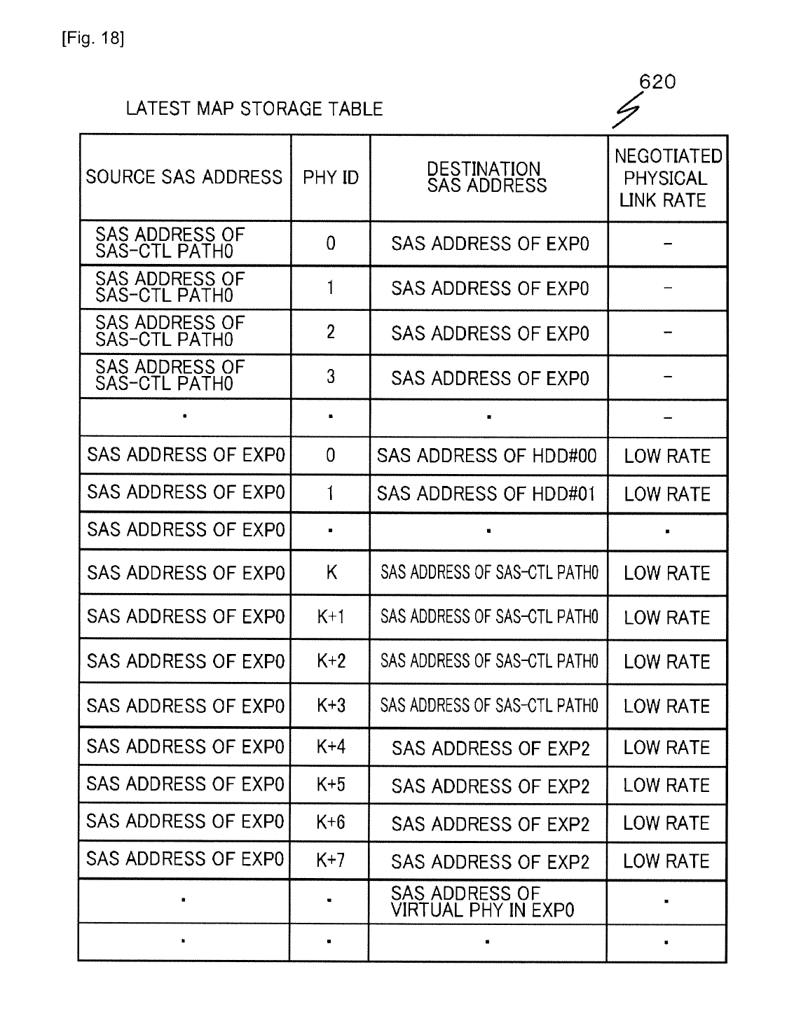

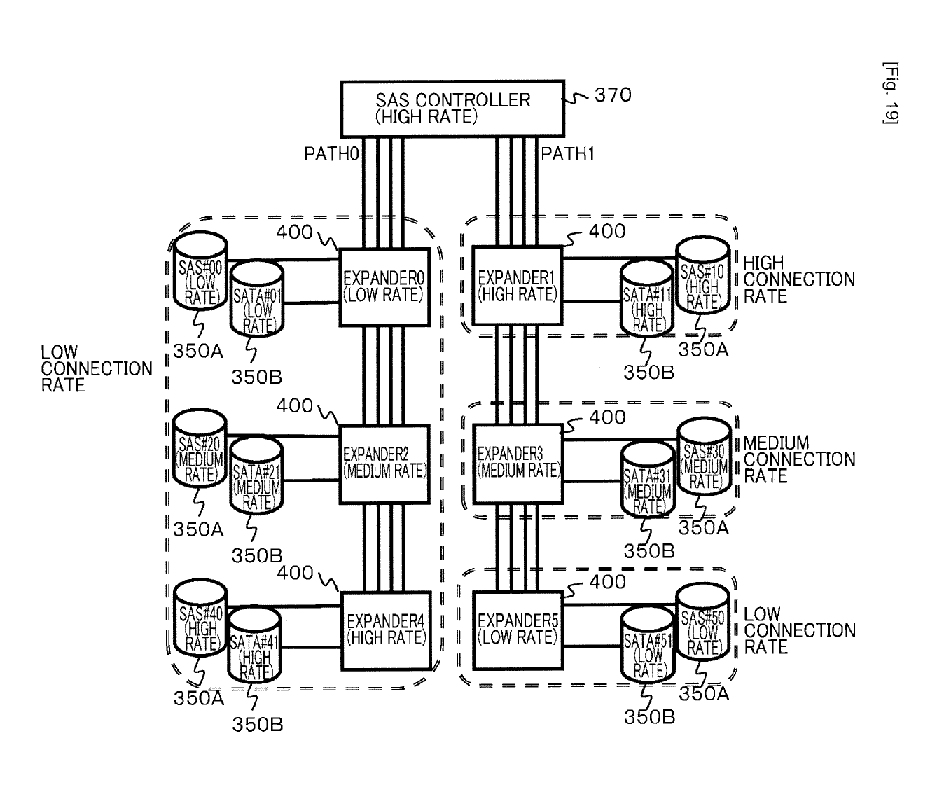

Every time the discover process on a devices in the storage apparatus 300 is completed, the controller 330 stores the information acquired through the discover process in the latest map storage table 620. FIG. 18 shows an example of the latest map storage table 620.

In the latest map storage table 620, the SAS address of a device coupled to each PHY 411 of each device, the negotiated link rate between coupled PHYs 411, and the like are written.

Here, as a matter of course, the controller 330 can acquire various kinds of information from the devices other than those described above through the discover process. In the following description, information acquired through the discover process will be described as needed.

=Connection Rate=

When an SAS address of a device in the storage apparatus 300 is identified through the discover process, the controller 330 can transmit various commands to the device while designating the SAS address of the device.

When transmitting these commands, the SAS controller 370 receives an instruction from the controller 330 and every time establishes a connection with the target device in accordance with the SAS standard.

In order to establish a connection with the target device, the SAS controller 370 transmits an open address frame to the device while designating the SAS address of the device in accordance with the SAS standard.

As shown in FIG. 10, the connection rate is written in the open address frame in accordance with the SAS standard. The connection rate is a communication rate determined between an initiator device and a target device. The connection rate will be described with reference to referring to FIG. 19.

In FIG. 19, a rate in parentheses attached to each device such as “(high rate)”, “(medium rate)” or “(low rate)” is the maximum communication rate of the device, i.e., a smaller value of the “programmed physical link rate” and the “hardware physical link rate.”

For example, when the “programmed physical link rate” is “(medium rate)” and the “hardware physical link rate” is “(high rate)”, the maximum communication rate is “(medium rate)”. Instead, when the “programmed physical link rate” is “(low rate)” and the “hardware physical link rate” is “(high rate)”, the maximum communication rate is “(low rate)”.

A “(low rate)” device can communicate only at the “low rate” with a device directly coupled to the device.

A “(medium rate)” device performs communications at “low rate” when a directly-coupled device is of “(low rate)”, and performs communications at “medium rate” when a directly-coupled device is of “(medium rate)”.

A “(high rate)” device performs communications at “low rate” when a directly-coupled device is of “(low rate)”, performs communications at “medium rate” when a directly-coupled device is of “(medium rate)”, and performs communications at “high rate” when a directly-coupled device is of “(high rate)”.

In this case, the communication rate, i.e., the connection rate between the initiator and the target depends on not only the maximum communication rates of the initiator and the target, but also the maximum communication rate of a device which relays communications between the initiator and the target.

For example, in FIG. 19, the connection rate between the SAS controller 370 and the storage drive #00 (350A) is “low rate” because the expander 0 (400) and the storage drive #00 (350A) are of “(low rate)” even though the SAS controller 370 is of “(high rate)”.

Meanwhile, the connection rate between the SAS controller 370 and the storage drive #40 (350A) is “low rate” because the expander 2 (400) is of “(medium rate)” and the expander 0 (400) is of “(low rate)” even though all of the SAS controller 370, the storage drive #40 (350A) and the expander 4 (400) are of “(high rate)”.

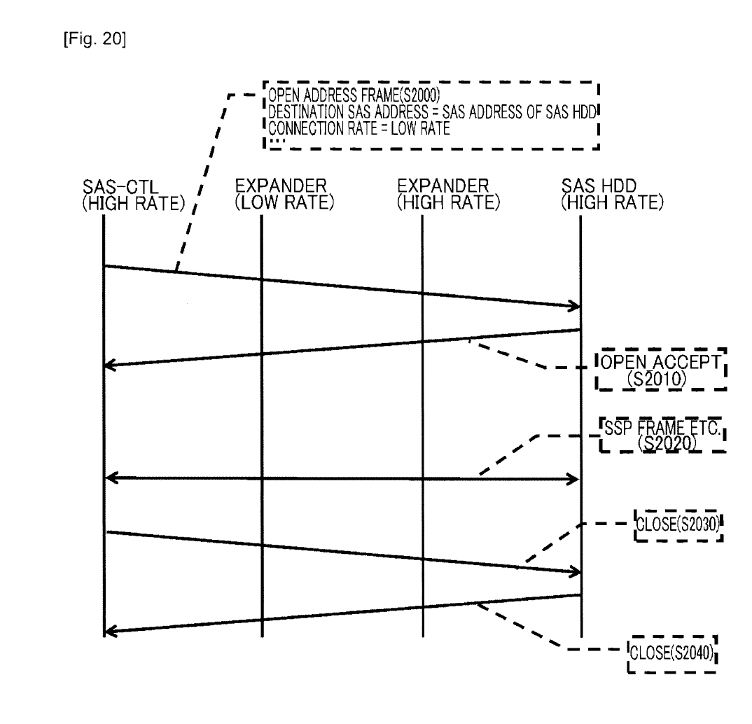

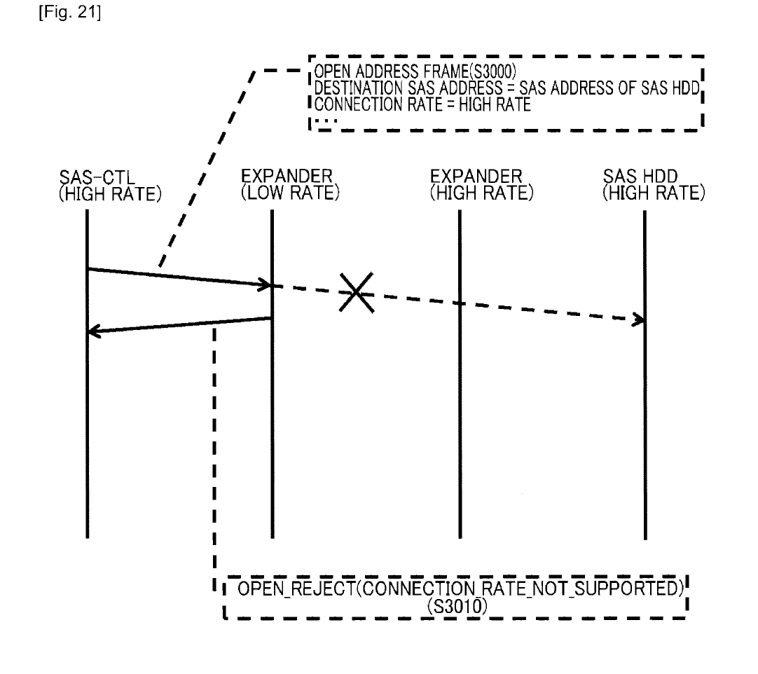

For example, in a case an open address frame is transmitted from the “(high rate)” SAS controller 370 to the “(high rate)” storage drive 350 via the “(low rate)” expander 400 and the “(high rate)” expander 400, as shown in FIG. 20. When the SAS controller 370 transmits the open address frame with the connection rate set to “(low rate)”, the open address frame is correctly forwarded by these expanders 400 along the path in turns and reaches the storage drive 350 (S2000). Thus, the storage 350 transmits the open accept (S2010). Then, the connection between the SAS controller 370 and the storage drive 350 is established, and the SAS controller 370 can transmits various commands to the storage drive 350 (S2020 to S2040).

In contrast, as shown in FIG. 21, when the SAS controller 370 transmits the open address frame with the connection rate set to “(high rate),” the open address frame is rejected by the “(low rate)” expander 400 and does not reach the storage drive 350 (S3000, S3010). As a result, the connection between the SAS controller 370 and the storage drive 350 cannot be established.

As with Path 0 in FIG. 19, when a “(low rate)” expander 400 is arranged on the upstream side even though “(high rate)” devices are arranged on the downstream side, the SAS controller 370 has no other choice but to set the connection rate between an initiator and a target to “low rate” due to the constraint of the maximum communication rate of the “(low rate)” expander 400 arranged on the upstream side.

To avoid this, if “(higher rate)” devices are arranged on the upper-stream side as with Path 1 in FIG. 19, the connection rate between an initiator and a target is not subjected to the constraint of the maximum communication rate of any device along the path.

As shown in the discover response in FIG. 16, the controller 330 acquires the programmed physical link rate (PROGRAMMED MAXIMUM PHYSICAL LINK RATE) and the hardware physical link rate (HARDWARE MAXIMUM PHYSICAL LINK RATE) from each device in the storage apparatus 300 when executing the discover process.

Hence, the controller 330 can acquire the maximum communication rate of each device.

Accordingly, on the basis of the acquired information, the controller 330 can determine the connection rate for communications with each of devices that can be a target in the storage apparatus.

Specifically, the controller 330 obtains the lowest value among the maximum communication rate of the controller 330, the maximum communication rate of a target device, and the maximum communication rate of each device along the path to the target device, and determines the lowest value as the connection rate for communications with the target device.

==Link Rate Error Determination Process==

Here, as described above, the hardware physical link rate and the programmed physical link rate are set in advance in each device, and the maximum communication rate of each device is a smaller value of the hardware physical link rate and the programmed physical link rate.

Meanwhile, when a new device is coupled to the storage apparatus 300, devices newly coupled to each other through the physical link 450 perform the link-up sequence process and make the speed negotiation.

The communication rate (negotiated link rate) determined by the speed negotiation is usually expected to be a lower one (expected communication rate) of the maximum communication rates of the devices.

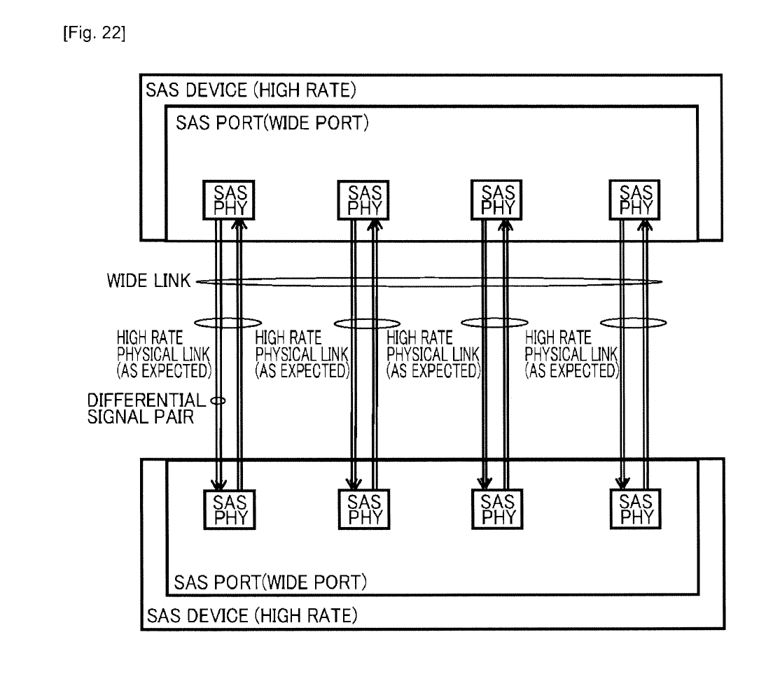

For example, as shown in FIG. 22, when the negotiated link rate is determined to be “high rate” for direct coupling between devices with maximum communication rates of “(high rate)”, the negotiated link rate is as expected.

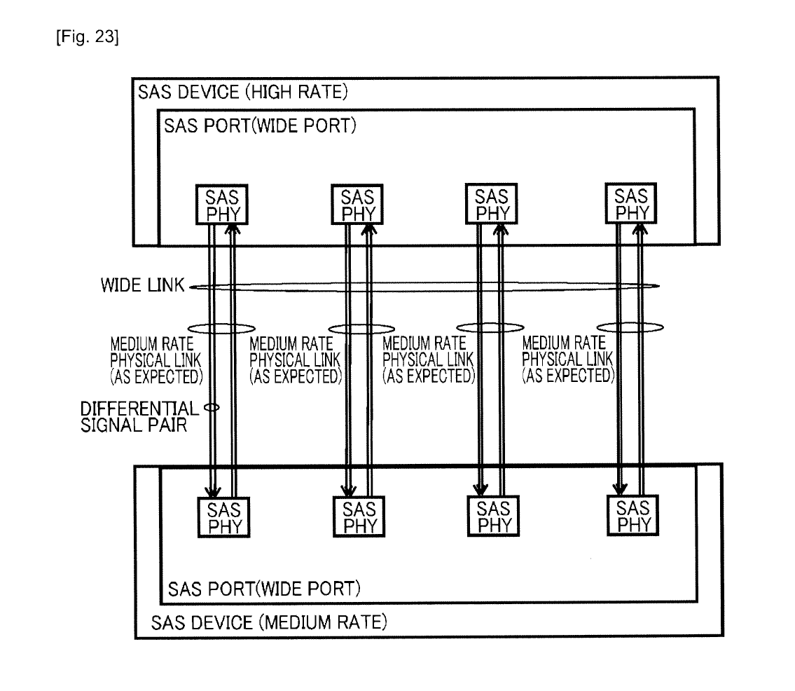

Moreover, as shown in FIG. 23, when the negotiated link rate is determined to be “medium rate” for direct coupling between a device with the maximum communication rate of “(high rate)” and a device with the maximum communication rate of “(medium rate)”, the negotiated link rate is as expected.

In contrast, the negotiated link rate may be set to a smaller value than the expected link rate in some cases due to some factor such as temporal noise contamination or a failure in the physical link 450.

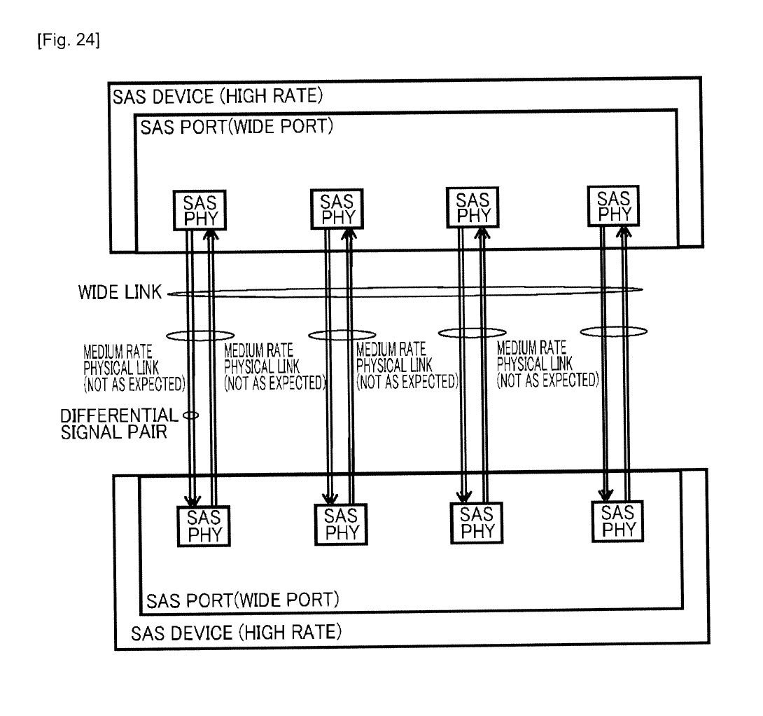

For example, as shown in FIG. 24, when the negotiated link rate is determined to be “medium rate” for direct coupling between devices with the maximum communication rates of “(high rate)”, the negotiated link rate is not as expected because communications are not performed at “high rate” which is achievable under normal circumstances.

The storage apparatus 300 according to the present embodiment is capable of determining whether or not the negotiated link rate between directly-coupled devices is as expected.

The controller 330 acquires the negotiated link rate from each device in the storage apparatus 300 when executing the discover process. In addition, as shown in the discover response in FIG. 16, the controller 330 also acquires the programmed physical link rate (PROGRAMMED MAXIMUM PHYSICAL LINK RATE) and the hardware physical link rate (HARDWARE MAXIMUM PHYSICAL LINK RATE) from each device in the storage apparatus 300 when executing the discover process.

In the discover process on a first device, firstly, the controller 330 according to the present embodiment acquires the programmed physical link rate and the hardware physical link rate of the first device, and obtains a smaller value of these rates as the first maximum communication rate of the first device.

In addition, in the discover process on the first device, the controller 330 acquires the first negotiated link rate established between the first device and a second device directly coupled to the first device.

Then, in the discover process on the second device, the controller 330 acquires the programmed physical link rate and the hardware physical link rate of the second device, and obtains a smaller value of these rates as the second maximum communication rate of the second device.

Moreover, in the discover process on the second device, the controller 330 acquires the second negotiated link rate established between the second device and the first device directly coupled to the second device.

Then, the controller 330 compares the first maximum communication rate, the second maximum communication rate, the first negotiated link rate and the second negotiated link rate with each other.

The controller 330 stores the comparison result in the memory 333 temporarily. The controller 330 determines that some kind of failure had occurred when the value of the first negotiated link rate and the value of the second negotiated link rate do not match with each other, and transmits the information indicating the failure occurrence to the management terminal 200.

A possible failure that occurs includes a hardware or software failure that occurs in the first device or the second device, and a failure that occurs in the physical link 450 coupling the first device and the second device to each other, for example. In this case, the controller 330 may execute a process to find a cause for the failure.

On the other hand, when the first negotiated link rate and the second negotiated link rate match with each other, the controller 330 obtains, as the expected communication rate, a smaller value of the first maximum communication rate and the second maximum communication rate.

Then, the controller 330 compares the expected communication rate and the first (or second) negotiated link rate with each other. The controller 330 stores the comparison result in the memory 333 temporarily.

After that, the controller 330 determines that the negotiated link rate is as expected when the expected communication rate and the first (or second) negotiated link rate match with each other.

In contrast, the controller 330 determines that the negotiated link rate is not as expected when the expected communication rate and the first (or second) negotiated link rate do not match with each other. In this case, the controller 330 determines that some kind of failure has occurred in the first device, the second device, or any location therebetween.

A possible failure that occurs includes a hardware or software failure that occurs in the first device or the second device, a failure that occurs in the physical link 450 coupling the first device and the second device to each other, and temporal noise, for example. In this case, the controller 330 may execute a process to find a cause for the failure.

The controller 330 transmits information such as the above comparison results, the determination result, the cause for the failure to the management terminal 200.

==Efficiency Improvement of Link Rate Error Determination Process==

The SAS standard with which the devices such as the SAS controller 370, the expanders 400, and the storage drives 350 accord according to the present embodiment includes several versions. In addition to SAS1 standard, SAS2 standard that is upper compatible with the SAS1 standard has been developed.

The SAS2 standard supports a discover list request in addition to the discover request transmitted to each device by the controller 330 in the discover process. In addition, the SAS2 standard supports a discover list response in addition to the discover response transmitted to the controller 330 by each device in the discover process. A term “discover list” will be also used below to indicate the discover list request and the discover list response, collectively.

The controller 330 compatible with the SAS2 standard is capable of executing the discover process on a plurality of (8 or 40) PHYs 411 at one time by transmitting the discover list request in the discover process. Details will be described below.

Incidentally, the controller 330 in accordance with the SAS2 standard can also transmit a discover request in the discover process, of course.

<Discover List>

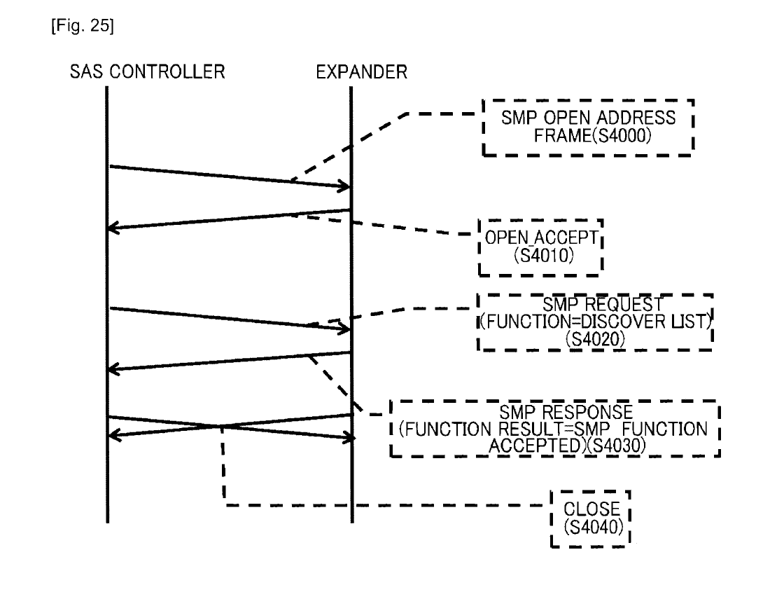

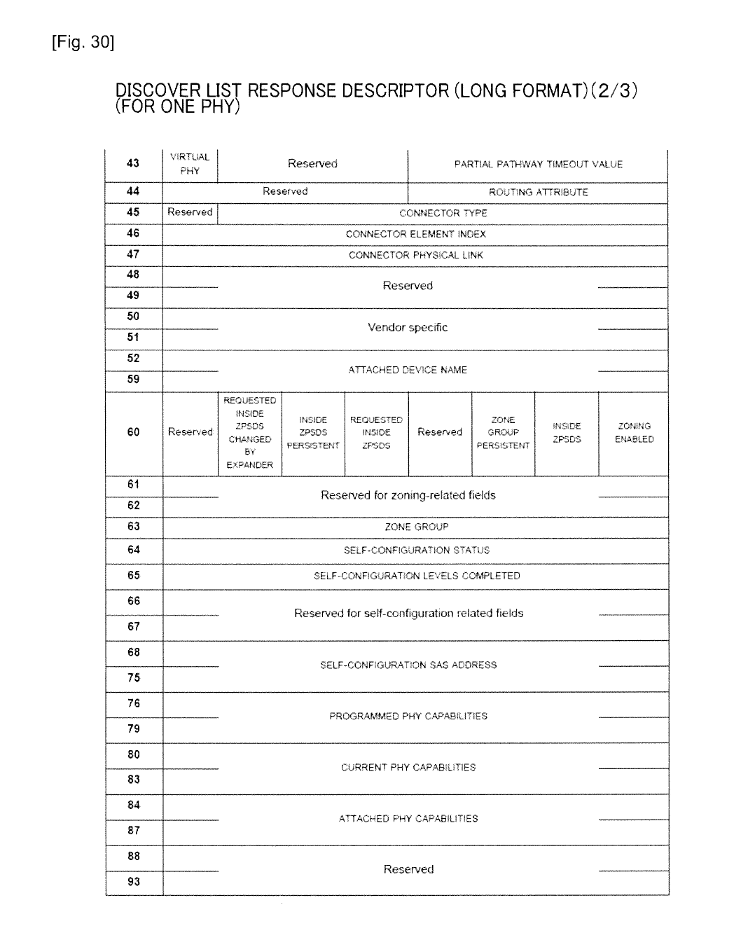

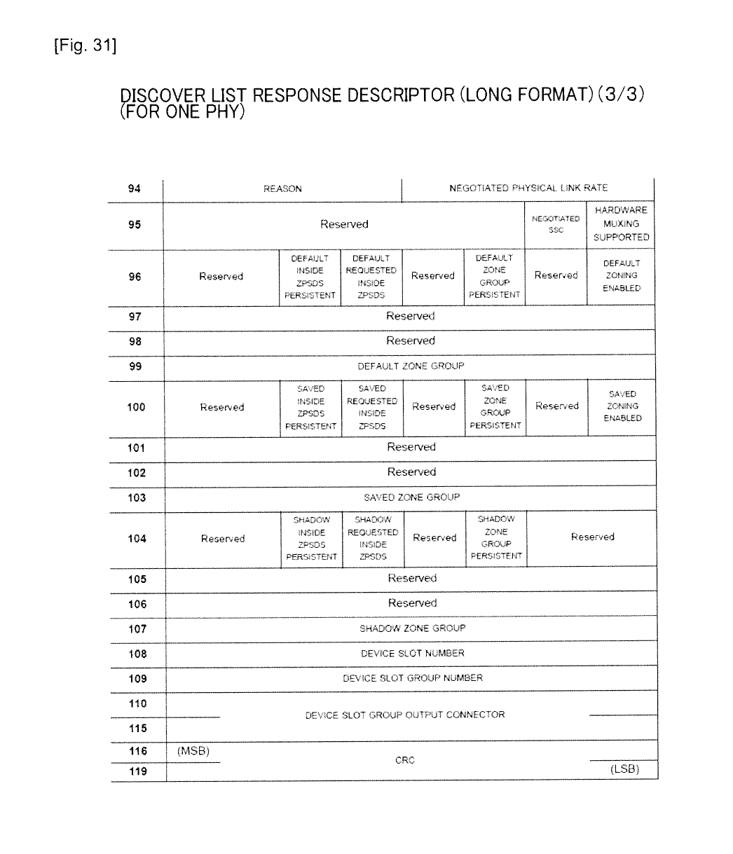

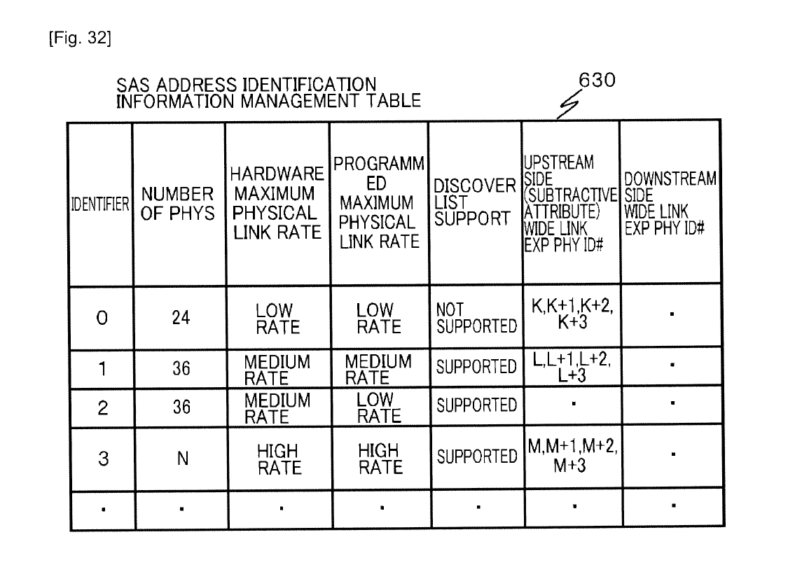

With reference to FIGS. 25 to 31, description will be provided for the discover process in which the SAS controller 370 transmits the discover list request to a discover target expander 400 and receives the discover list response.

In response to an instruction from the CPU 331, the SAS controller 370 firstly establishes the connection with a discover target expander 400. Here, the SAS controller 370 can acquire the SAS address of the expander 400 to be performed discover first with reference to the IAF management table 600. Specifically, the expander 400 to be performed discover first is an expander 400 directly coupled to the controller 330.

In order to establish the connection with the discover target expander 400, the SAS controller 370 transmits an open address frame to the expander 400 while designating the SAS address of the expander 400 in accordance with the SAS standard (S4000). The open address frame is received by the SMP target port 430 in the discover target expander 400.

When the SAS controller 370 receives an open accept from the expander 400 (S4010), the connection between the SAS controller 370 and the expander 400 is established. With this, the SAS controller 370 can perform the discover process on the expander 400.

Then, the SAS controller 370 transmits an SMP request to the expander 400 with which the connection is established (S4020). In the SMP request, “discover list request” is designated as an argument.

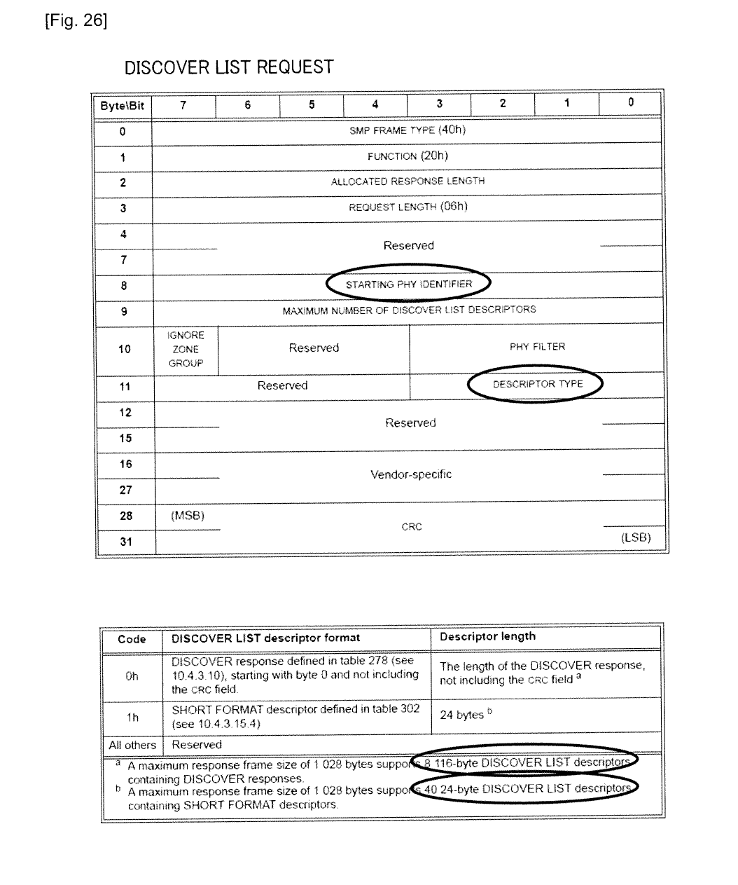

FIG. 26 shows a content of the discover list request.

The discover list request includes a STARTING PHY IDENTIFIER field. In the STARTING PHY IDENTIFIER field, written is the PHY ID of the PHY 411 as a discover starting point among multiple (8 or 40) PHYs 411 targeted for the discover process in the discover list request.

In addition, the discover list request includes a DESCRIPTOR TYPE field. In the DESCRIPTOR TYPE field, written is information indicating whether or not a short format is used by the discover target device to transmit the discover list response.

Specifically, when the SAS controller 370 transmits the discover list request to the discover target device with “1h” written in the DESCRIPTOR TYPE field, the device transmits the discover list response in the short format.

In contrast, when the SAS controller 370 transmits the discover list request to the discover target device with “0h” written in the DESCRIPTOR TYPE field, the device transmits the discover list response in a format (also called a long format below) other than the short format.

As shown in FIG. 26, the discover list response in the short format includes discover results of up to 40 PHYs 411 at one time. In contrast, the discover list response in the long format includes discover results of up to 8 PHYs 411 at one time. The short format and the long format will be described later.

The SAS controller 370 writes the PHY ID of the PHY 411 designated as the discover starting point in the STARTING PHY IDENTIFIER field, writes information designating the short format or the long format in the DESCRIPTOR TYPE field, and then transmits the aforementioned SMP request to the discover target expander 400 (S4020).

Upon receiving this SMP request, the SMP target port 430 in the expander 400 acquires a SAS address (ATTACHED SAS ADDRESS), an ATTACHED PHY ID, and a NEGOTIATED LINK RATE of a device directly coupled to each of the PHYs 411 having the PHY IDs consecutive from the PHY ID of the PHY 411 identified by use of the PHY ID written in the STARTING PHY IDENTIFIER field. These information are acquired by each PHY 411 itself from the directly-coupled device in the aforementioned link-up sequence process, and are stored in the memory 412 included in the PHY 411.

The SMP target port 430 writes these kinds of information acquired from the PHY 411 to predetermined fields in the discover list response, and transmits the discover list response to the SAS controller 370 (S4030).

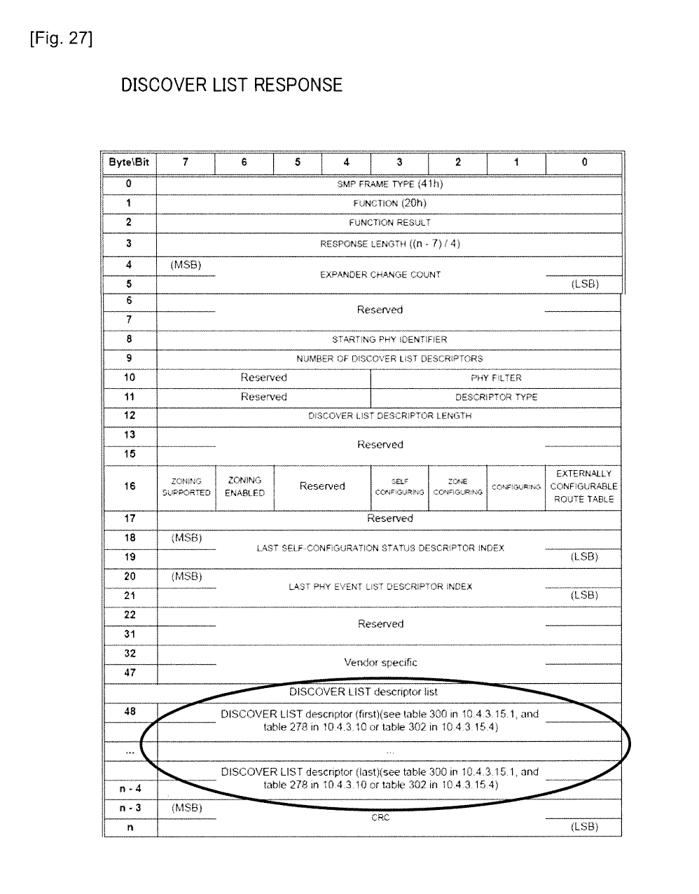

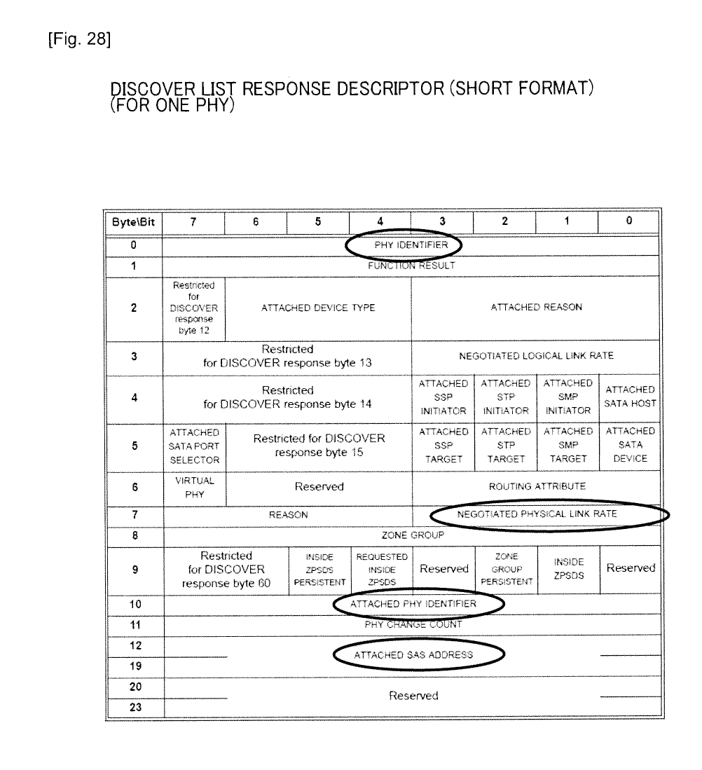

FIG. 27 shows a content of the discover list response. In the case of the short format, a maximum of 40 descriptors, a content of each of which is shown in FIG. 28, are written in the 48-th byte and following bytes in the discover list response. The descriptor shown in FIG. 28 is information for one PHY (411).

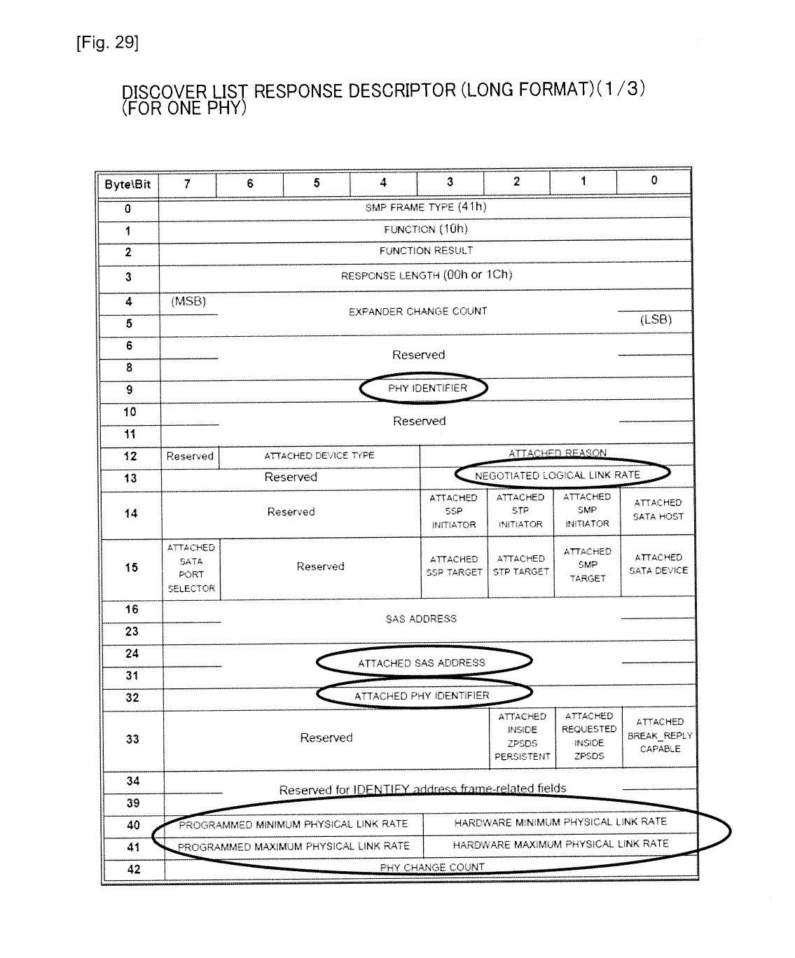

In the case of the long format, a maximum of 8 descriptors, a content of each of which is shown in FIGS. 29 to 31, are written. The descriptor shown in FIGS. 29 to 31 is information for one PHY (411).

As shown in FIGS. 29 to 31, in the long format, the ATTACHED SAS ADDRESS, the ATTACHED PHY ID, the NEGOTIATED LOGICAL LINK RATE, the PROGRAMMED MAXIMUM PHYSICAL LINK RATE, the HARDWARE MAXIMUM PHYSICAL LINK RATE are written in the descriptor.

In contrast, in the short format, the ATTACHED SAS ADDRESS, the ATTACHED PHY ID and the NEGOTIATED PHYSICAL LINK RATE are written in the descriptor as shown in FIG. 28. In the short format, the PROGRAMMED MAXIMUM PHYSICAL LINK RATE and the HARDWARE MAXIMUM PHYSICAL LINK RATE are not included in the descriptor.

Upon receiving the discover list response from the discover target expander 400, the SAS controller 370 closes the connection with the expander 400 (S4040). Similarly, the expander 400 closes the connection with the SAS controller 370 (S4040).

The SAS controller 370 performs the above process on all the PHYs 411 in the discover target expander 400.

Since the SAS controller 370 performs the report general process and acquires the number of PHYs 411 in the discover target expander 400 before starting the discover process, the SAS controller 370 can determine whether or not the discover process is completed for all the PHYs 411 in the discover target expander 400.

In this way, use of the discover list request and the discover list response in accordance with the SAS2 standard enables information acquisition for a maximum of 8 or 40 PHYs 411 in a single execution of the discover process. This, in turn, enables large reduction in time needed for acquiring information from all the PHYs 411 in the entire storage apparatus 300.

In the case where the short format is selected, especially, information on 40 PHYs 411 can be obtained at one time. Thus, even a large scale storage apparatus 300 including an extremely large number of storage drives 350 can complete the discover process within a short time.

<Efficiency Improvement of Link Rate Error Determination Process>

As mentioned above, in the case of the long format, the NEGOTIATED LOGICAL LINK RATE, the PROGRAMMED MAXIMUM PHYSICAL LINK RATE and the HARDWARE MAXIMUM PHYSICAL LINK RATE are written in the descriptor in the discover list response.

Thus, in the case of the long format, the controller 330 can determine whether the negotiated link rate between directly-coupled devices is as expected or not, on the basis of the above information acquired through the discover process.

In the case of the short format, however, the PROGRAMMED MAXIMUM PHYSICAL LINK RATE and the HARDWARE MAXIMUM PHYSICAL LINK RATE are not included in the descriptor.

For this reason, in the case of the short format, the controller 330 cannot determine whether or not the negotiated link rate between directly-coupled devices is as expected, if the controller 330 uses only the above information acquired through the discover process.

Here, as shown in FIG. 2, the controller 330 in the storage apparatus 300 according to the present embodiment includes the SAS address identification information management table 630 in the memory 333.

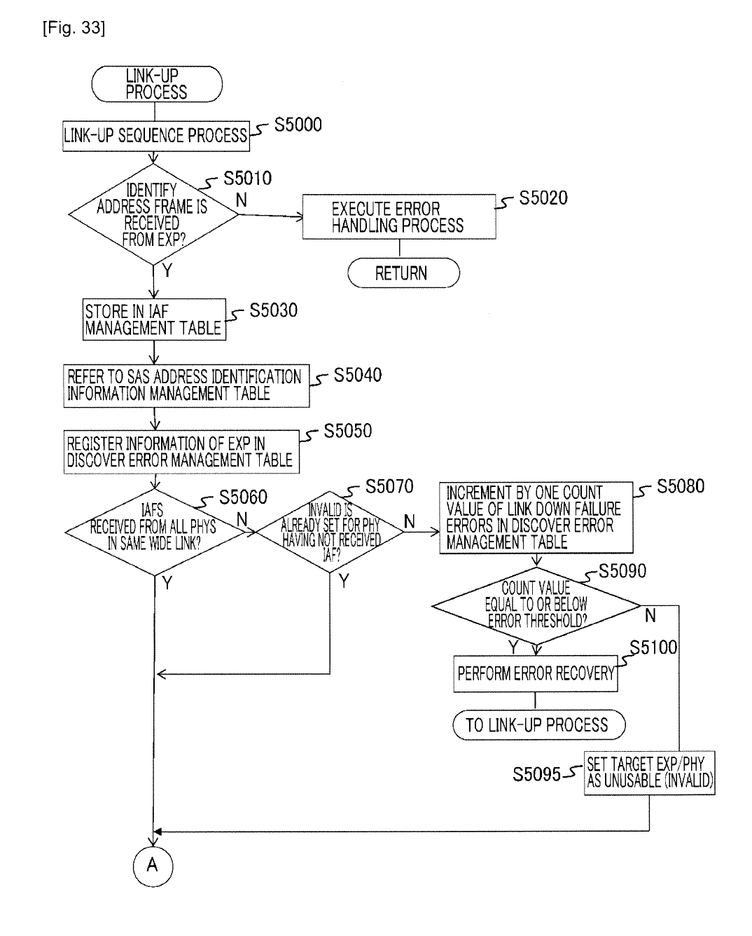

The SAS address identification information management table 630 is a table having listed therein specifications of devices such as SAS controllers 370, expanders 400, and storage drives 350. FIG. 32 shows a SAS address identification information management table 630.

In the “identifier” field, identification information (specification ID) for uniquely identifying each specification is written. In the “NUMBER OF PHYS” field, the number of PHYs included in the device having the specification identified by use of the specification ID is written. In the “HARDWARE MAXIMUM PHYSICAL LINK RATE” field, the hardware physical link rate set for the device having the specification identified by use of the specification ID is written. In the “PROGRAMMED MAXIMUM PHYSICAL LINK RATE” field, the programmed physical link rate set for the device having the specification identified by use of the specification ID is written.

In the “DISCOVER LIST SUPPORT” field, written is information indicating whether or not the device having the specification identified by use of the specification ID is in accordance with the SAS2 standard. In the “UPSTREAM-SIDE WIDE LINK EXP PHY ID#” field, the PHY ID of a PHY 411 directly coupled to an upstream-side device is written. In the “DOWNSTREAM-SIDE WIDE LINK EXP PHY ID#” field, the PHY ID of a PHY 411 directly coupled to a downstream-side device is written.

As described above, each device of SAS controllers 370, expanders 400, and storage drives 350 according to the present embodiment stores the SAS address in the memory or the like included therein, and the “VENDOR-SPECIFIC IDENTIFIER” field in the SAS address has the above specification ID written therein.

As described above, in the discover process on each device in the storage apparatus 300, the controller 330 collects, from the device, the SAS address of the device, and the SAS address (ATTACHED SAS ADDRESS) of a device directly coupled to the device.

Accordingly, by referring to the SAS address identification information management table 630 using the specification ID written in the SAS address collected from each device, the controller 330 can acquire the number of PHYs 411 included in the device, as well as the hardware physical link rate, the programmed physical link rate and the like of the device.

In this way, by using the specification ID written in the SAS address collected from each device, the storage apparatus 300 according to the present embodiment can obtain the hardware physical link rate and the programmed physical link rate stored in association with the specification ID in the SAS address identification information management table 630.

Thus, in the storage apparatus 300 according to the present embodiment, even in the case where the discover process is performed in the short format, the controller 330 can determine whether or not the negotiated link rate between directly-coupled devices is as expected, on the basis of the information acquired through the discover process.

Specifically, upon directly coupling an expander 400 to the controller 330, the SAS controller 370 and the expander 400 firstly make the speed negotiation therebetween. Then, the negotiated link rate is written to the memory 412 in each PHY 411 included in the SAS controller 370.

Next, the SAS controller 370 and the expander 400 exchange the identify address frames therebetween. Thereby, the expander 400 transmits the SAS address to the controller 330 and the controller 330 acquires the SAS address of the expander 400.

After that, the controller 330 identifies the maximum communication rate of the expander 400 by referring to the SAS address identification information management table 630 using the specification ID written in the SAS address of the expander 400. More specifically, the controller 330 identifies as the maximum communication rate of the expander 400 a lower one of the hardware physical link rate and the programmed physical link rate.

In the present embodiment, whether or not the communication rate (negotiated link rate) between the controller 330 and the expander 400 matches with the expected communication rate can be determined at this time point.

The controller 330 identifies the maximum communication rate of the SAS controller 370 by using the specification ID written in the SAS address of the SAS controller 370 stored in the memory or the like in the SAS controller 370. Specifically, the controller 330 acquires the programmed physical link rate and the hardware physical link rate 370, and obtains a smaller value of the two rates as the maximum communication rate (first maximum communication rate) of the SAS controller 370.

In addition, the controller 330 acquires the negotiated link rate established between the SAS controller 370 and the expander 400 and stored in the memory 412 in the PHY 411 in the SAS controller 370.

Then, the controller 330 acquires the programmed physical link rate and the hardware physical link rate of the expander 400 by using the specification ID written in the SAS address of the expander 400, and obtains a smaller value of the two rates as the maximum communication rate (second maximum communication rate) of the expander 400.

After that, the controller 330 obtains as the expected communication rate a smaller value of the first maximum communication rate and the second maximum communication rate. Thereafter, the controller 330 compares the expected communication rate and the negotiated link rate with each other and stores the comparison result in the memory 333.

When the expected communication rate and the negotiated link rate match each other, the controller 330 determines that the negotiated link rate is as expected.

On the other hand, when the expected communication rate and the negotiated link rate do not match each other, the controller 330 determines that the negotiated link rate is not as expected. The controller 330 may transmit the comparison result to the management terminal 200.

Then, the controller 330 acquires whether or not the expander is in accordance with the SAS2 standard, on the basis of the SAS address of the above-mentioned expander 400 acquired through the exchange of the identify address frames.

When the expander 400 is in accordance with the SAS2 standard, the controller 330 can transmit the discover list request to the expander 400 while designating the short format. Instead, the controller 330 may designate the long format, or may transmit the discover request, as a matter of course.

The controller 330 transmits the discover list request with the short format designated therein to the expander 400.

When receiving the discover list response in the short format from the expander 400, the controller 330 can acquire information on 40 PHYs 411 at one time.

After that, in the same manner, the controller 330 can determine whether or not the negotiated link rate between directly-coupled devices is as expected, in every execution of the discover process.

To be more specific, by executing the discover process on a first device (for example, the expander 400), the controller 330 acquires, from the first device, the SAS address of a second device (for example, the expander 400 of the following stage), which is directly coupled to the first device not yet subjected to the discover process (such a device will be also called a pre-discover device below), and also acquires the negotiated connection rate between the first device and the second device.

The controller 330 identifies the maximum communication rate of the second device on the basis of the SAS address of the second device.

The controller 330 also identifies the maximum communication rate of the first device on the basis of the SAS address of the first device.

In addition, the controller 330 obtains, as the expected communication rate between the first device and the second device, a lower one of the maximum communication rate of the first device and the maximum communication rate of the second device.

Then, the controller 330 compares the expected communication rate between the first device and the second device with the negotiated connection rate between the first device and the second device, and thereby determines whether or not the negotiated link rate matches the expected communication rate.

As described above, in the present embodiment, the above determination can be made before the discover process on the second device is executed, and therefore a failure can be detected earlier than otherwise. In addition, when a failure is detected, the discover process on the second device, for example, can be cancelled. In this way, the process can be streamlined.

Moreover, the process of determining whether or not the negotiated link rate between the directly-coupled devices is as expected can be carried out through the discover process using the short format, and therefore can be completed within a shorter time than otherwise.

In addition, even when devices only in accordance with the SAS1 standard, and devices in accordance with the SAS1 and SAS2 standards are both included in the storage apparatus 300, the controller 330 can determine whether or not a discover target device is compatible with the SAS2 standard before the discover process just about to be executed by acquiring the SAS address of a discover target device in advance, and by referring to the SAS address identification information management table 630 using the specification ID written in the SAS address.

Thus the controller 330 can transmit, without fault, either of the discover request and the discover list request according to the SAS standard supported by the discover target device.

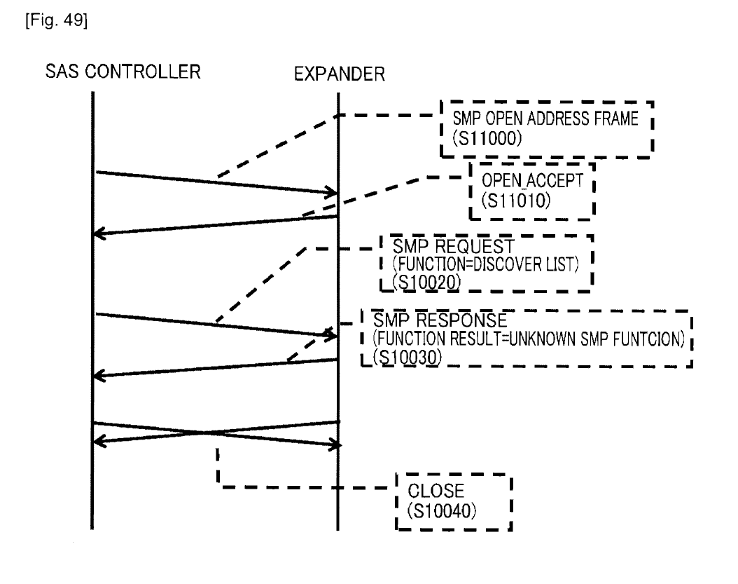

Accordingly, the discover process does not have to include processing of transmitting the discover list request from the controller 330 to the device and confirming that the device is in accordance with the SAS2 standard according to whether or not unknown is returned as a reply from the device as shown in FIG. 49. Thus, the time required for the discover process can be further reduced.

<Setup of RAID Group>

The apparatus 300 according to the present embodiment can correctly set the connection rate between the SAS controller 370 and each device (each expander 400, each storage drive 350) in the foregoing manner.

When configuring RAID by using the storage drives 350 included in the storage apparatus 300, an operator operating the management terminal 200 selects the storage drives 350, one by one, to constitute the RAID in consideration of several elements such as type of the storage drive 350 (SAS, SATA or the like), storage capacity, date of manufacture, data read rate and write rate, for example.

In the storage apparatus 300 according to the present embodiment, a RAID group 340 can be formed by using storage drives 350 having the same connection rate. When a RAID group 340 is formed using the storage drives 350 having the same connection rate, the processes for data I/O requests from the server 100 can be executed while making maximum use of the communication rate of communications between the SAS controller 370 and the RAID group 340.

==Process Flow==

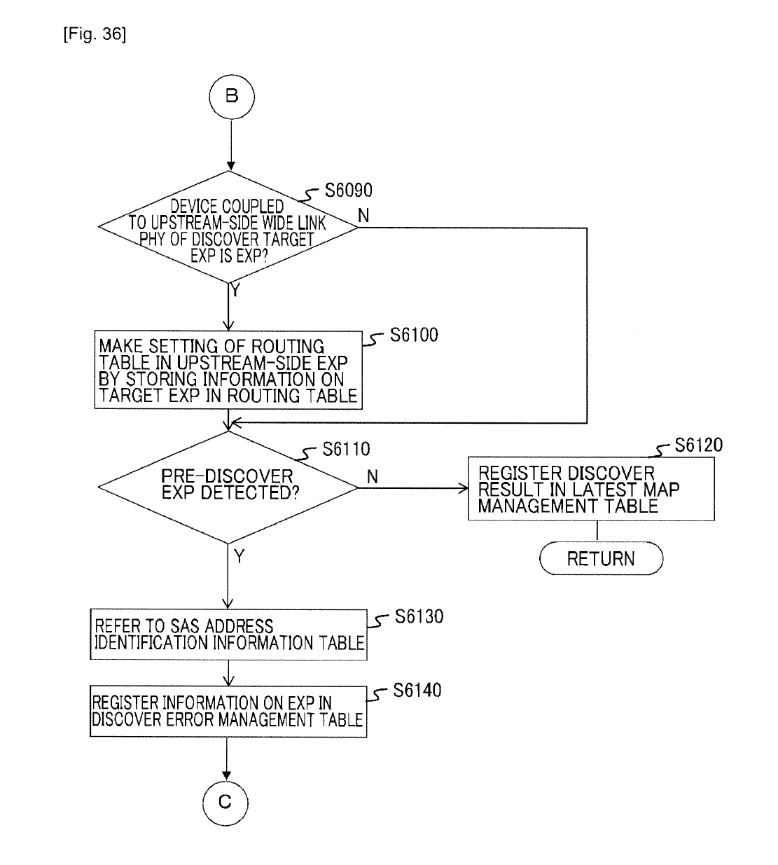

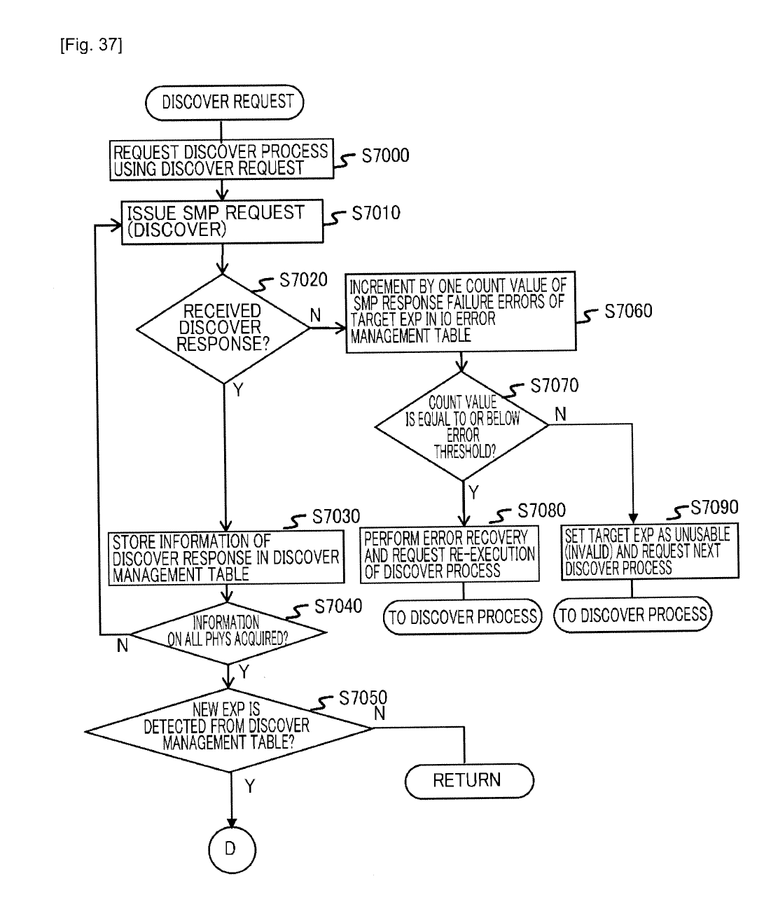

Hereinafter, flows of the foregoing processes will be described with reference to FIGS. 33 to 42.

<Link Up>

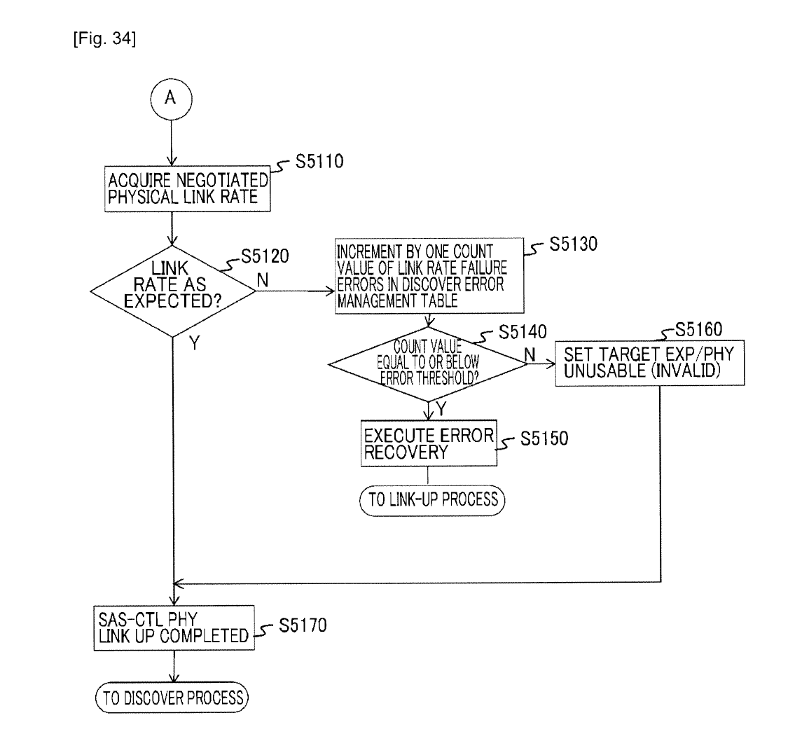

First, with reference to flowcharts in FIGS. 33 and 34, description will be provided for the process (link-up process) performed when an expander 400 is newly coupled to the SAS controller 370.

The SAS controller 370 firstly executes the link-up sequence process (S5000).

Specifically, the SAS controller 370 executes the speed negotiation process and the identify address frame exchange process, as described above.

Then, the controller 330 determines whether or not the SAS controller 370 has correctly received the identify address frame (S5010). When the SAS controller 370 has not, the process advances to “N” and the controller 330 executes a predetermined error handling process (S5020).

When the SAS controller 370 has received the identify address frame, the process advances to “Y” and the controller 330 stores, in the IAF management table 600, the SAS address of the expander 400 directly coupled to each PHY 411 of the SAS controller 370 and the PHY ID of each PHY 411 of the expander 400 (S5030).

Thereafter, the controller 330 acquires the hardware physical link rate and the programmed physical link rate of the expander 400 identified by use of the specification ID in the SAS address of the expander 400 by referring to the SAS address identification information management table 630 using the SAS address of the directly coupled expander 400 stored in the IAF management table 600 (S5040).

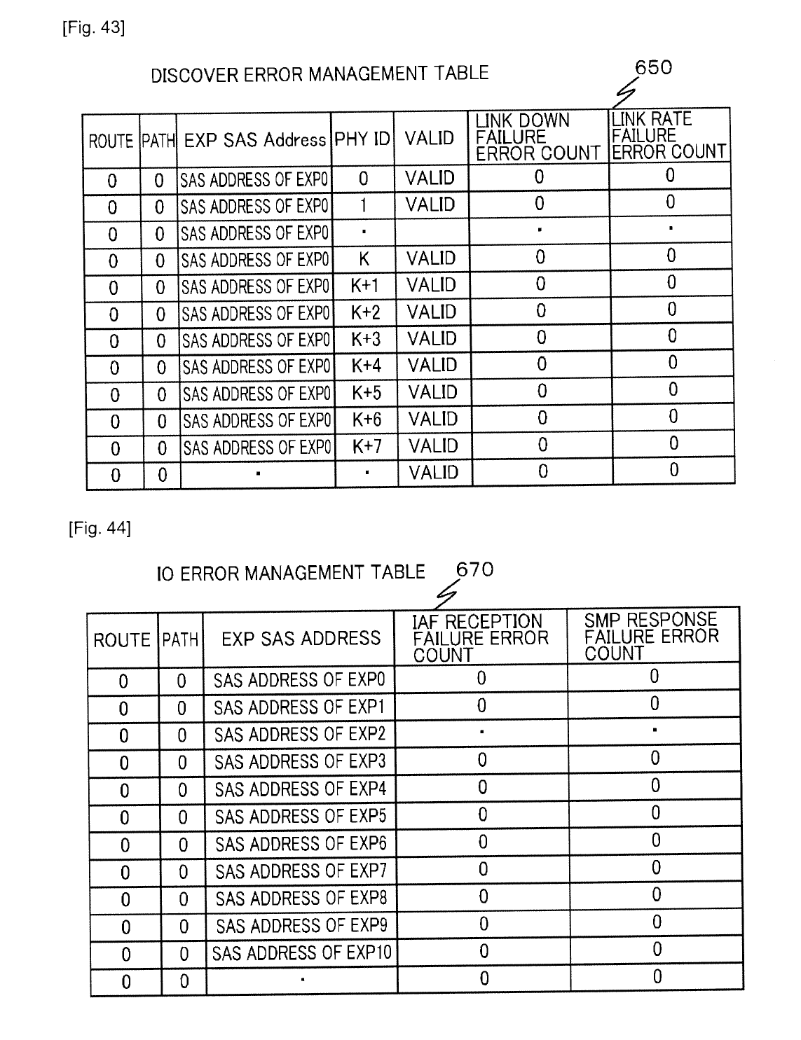

In addition, the controller 330 stores the SAS address of the expander 400 and the PHY ID of each PHY 411 of the expander 400 in the discover error management table 650 (S5050). FIG. 43 shows the discover error management table 650. The discover error management table 650 is provided with a valid field and an error count field for each PHY 411 of each device such as an expander 400 or the like.

Information indicating whether or not the PHY 411 is usable for data transmission and reception is recorded in the valid field. For example, when a particular PHY 411 has a failure or the like, “invalid” is set therein to make the PHY 411 unusable for data transmission and reception. On the other hand, “valid” is set when the PHY 411 is usable for data transmission and reception.

In the error count field, the number of detected link down failure errors and the number of detected link rate failure errors are recorded. Details will be described later.

Next, the controller 330 determines whether or not the identify address frames have been received from all the PHYs in the same wide link 451 (S5060). When there is a PHY 411 from which the identify address frame is not received, the process advances to “N” and the controller 330 determines whether or not the PHY 411 is set as invalid by referring to the discover error management table 650 (S5070).

If invalid is not set, the controller 330 increments by one the number of detected link down failure errors of the PHY 411 (S5080). If the count value does not exceed a threshold (S5090), the controller 330 executes a predetermined error recovery process (S5100) and re-executes the link-up process. If the count value exceeds the threshold, the controller 330 sets invalid (S5095).

On the other hand, when the identify address frames have been received from all PHYs 411 in the same wide like 451 in S5060, or when the PHY 411 from which the identify address frame is not received is set as invalid in S5070, the controller 330 advances to the next process.

The controller 330 acquires the negotiated link rate for each PHY 411 in the SAS controller 370 stored in the memory 412 of the PHY 411 (S5110).

Then, the controller 330 obtains the expected communication rate on the basis of the hardware physical link rate and the programmed physical link rate stored in the memory of the SAS controller 370 and the hardware physical link rate and the programmed physical link rate (acquired in S5040) of the expander 400 identified by use of the specification ID in the SAS address of the expander 400, and determines whether or not the expected communication rate matches the negotiated link rate (S5120).

As a result, if these rates match, the process advances to “Y” and the controller 330 terminates the link-up process (S5170).

On the other hand, if these rates do not match, the process advances to “N” from S5120 and the controller 330 increments by one the count value of link rate failure errors in the discover error management table 650 (S5130). If the count value does not exceed a threshold (S5140), the controller 330 executes a predetermined error recovery process (S5150), and re-executes the link-up process.

If the count value exceeds the threshold, the controller 330 sets invalid (S5160) and terminates the link-up process (S5170).

<Discover Process>

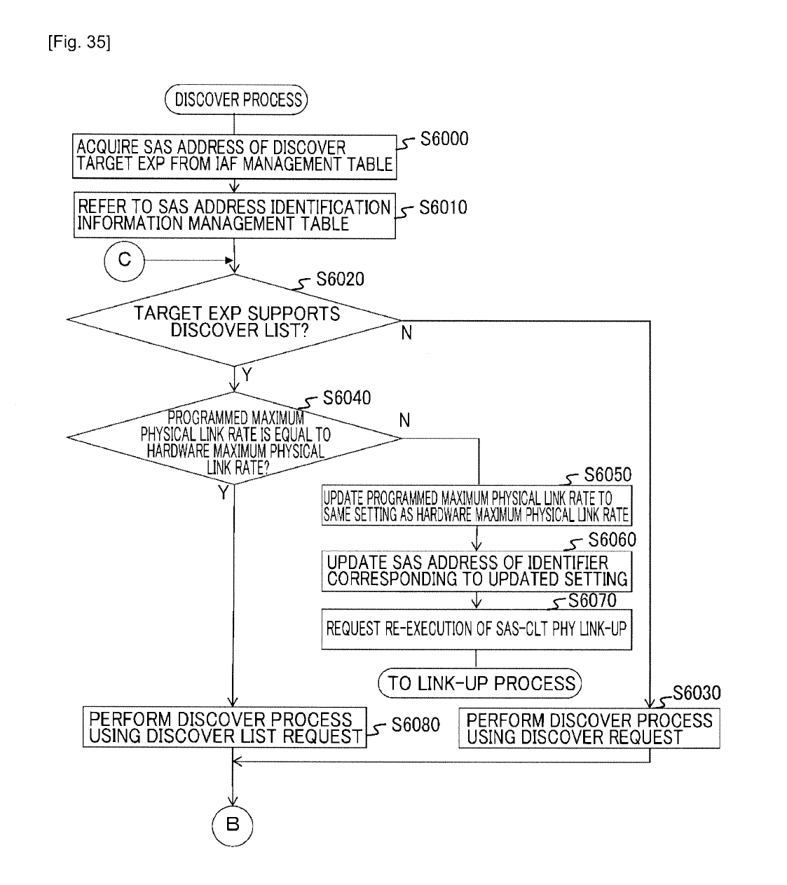

Subsequently, the controller 330 executes the discover process. A flow of the discover process will be described with reference to the flowcharts in FIGS. 35 to 40.

First of all, the controller 330 acquires the SAS address of an expander 400 directly coupled to the SAS controller 370 by referring to the IAF management table 600 (S6000).

Then, the controller 330 acquires the information indicating whether or not the expander 400 supports the discover list request by referring to the SAS address identification information management table 630 using the specification ID written in the SAS address (S6010).

As a result, if the expander 400 does not support the discover list request, the process advances to “N” from S6020, and the controller 330 executes the discover process on the expander 400 by using the discover request defined in the SAS1 standard (S6030).

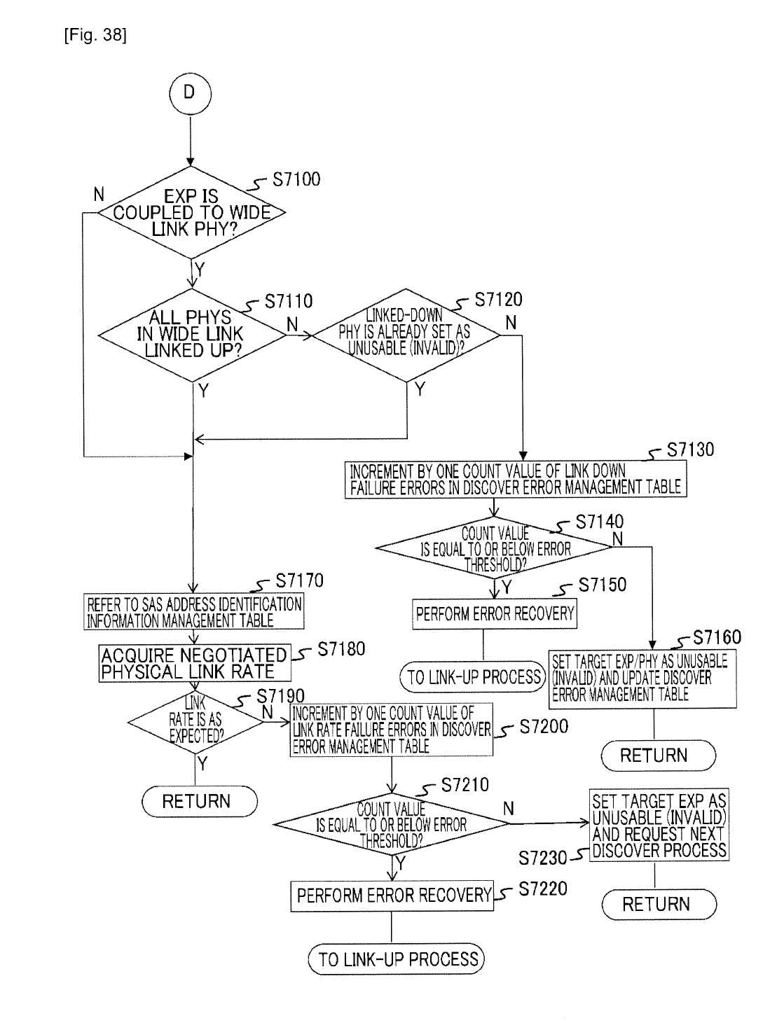

Hereinafter, by referring to FIGS. 37 and 38, description will be provided for the process in which the controller 330 executes the discover process on the expander 400 by using the discover request defined in the SAS1 standard.

The controller 330, at first, instructs the SAS controller 370 to execute the discover process using the discover request (S7000).

In response to this, the SAS controller 370 transmits the SMP request of the discover request to the discover target expander 400 (S7010).

When the SAS controller 370 does not receive the discover response from the expander 400 within a predetermined time period, the controller 330 advances to “N” from S7020 and increments by one an SMP response error count value in the IO error management table 670 (S7060)

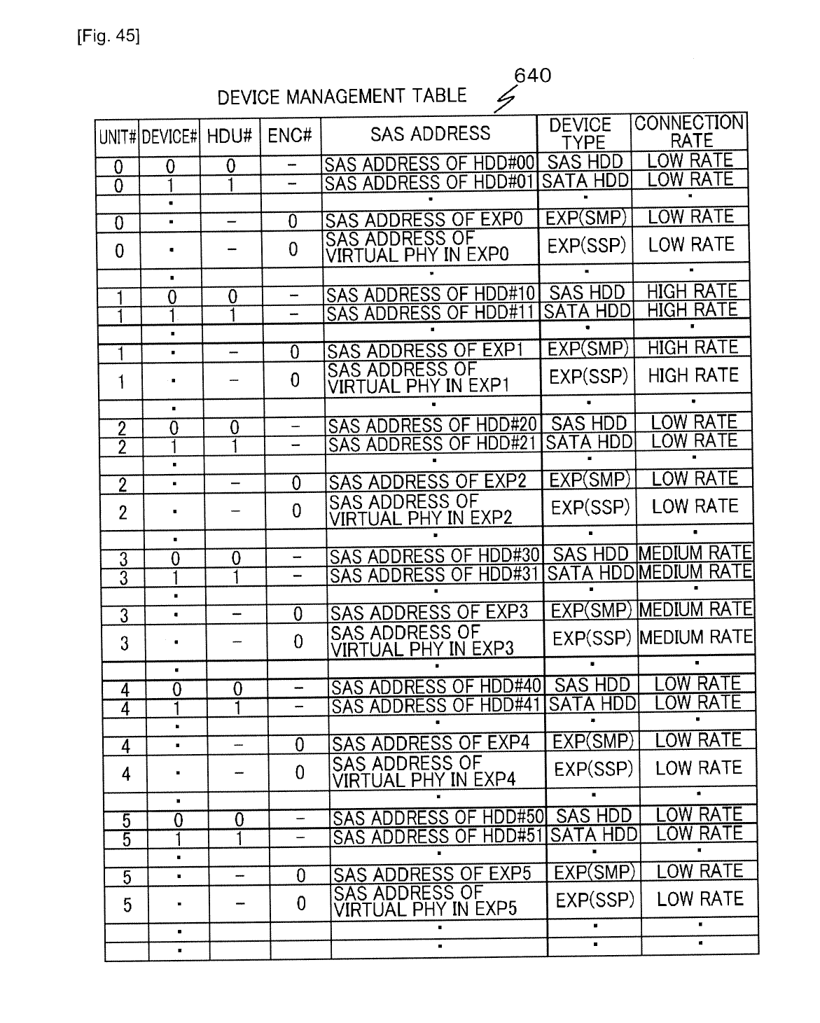

FIG. 44 shows IO error management table 670. The IO error management table 670 includes an IAF reception failure error count field and an SMP response failure error count field.

If the count value does not exceed a threshold (S7070), the controller 330 executes a predetermined error recovery process (S7080) and re-executes the discover process.

If the count value exceeds the threshold, the controller 330 sets the expander 400 as invalid in the discover error management table 650 and executes the next discover process (S7090).

On the other hand, when the SAS controller 370 receives the discover response from the expander 400 within the predetermined time period in S7020, the controller 330 advances to “Y” and stores the content of the discover response received from the expander 400 in the discover management table 610 (S7030).

Then, the controller 330 determines whether or not the discover process is completed for all the PHYs 411 in the expander 400 (S7040). If there is a pre-discover PHY 411, the controller 330 returns to S7010 and executes the discover process on the pre-discover PHY 411.

When the discover process is completed for all the PHYs 411 in the expander 400, the controller 330 determines in S7050 whether or not a newly found device in the above discover process is an expander 400 (S7050).

If the newly found device is not an expander 400, the controller advances to “N” from S7050 and terminates the process in S6030.

If the newly found device is an expander 400, the controller advances to “Y” from S7050 and determines whether or not the expander 400 is coupled to a wide link 451 (S7100).

If the expander 400 is coupled to the wide link 451, the controller 330 determines whether or not all the PHYs 411 in the wide link 451 are linked up (S7110).

If there is a PHY 411 not linked up, the controller 330 advances to “N” from S7110, and increments by one the count value of link down failure errors in the discover error management table 650 (S7130). If the count value does not exceed the threshold (S7140), the controller 330 executes the predetermined error recovery process (S7150) and re-executes the link-up process.

If the count value exceeds the threshold, the controller 330 sets invalid (s7160) and terminates the process in S6030.

In any of the cases where the expander 400 is not coupled to the wide link 451 (S7100), where all the PHYs 411 in the wide link 451 are linked up even if the expander 400 is coupled to the wide link 451 (S7110), and where any of the PHYs 411 is set as invalid even if there is a PHY 411 not being linked up (S7120), the controller 330 refers to the SAS address identification information management table 630 using the SAS address of the expander 400 (already acquired through the discover response) (S7170) and acquires the hardware physical link rate and the programmed physical link rate of the expander 400 identified by use of the specification ID in the SAS address of the expander 400 (S7170).

Then, the controller 330 acquires the negotiated link rate stored in the memory 412 of each PHY 411 of the expander 400 after discover process (S7180).

Thereafter, the controller 330 obtains the expected communication rate between the expanders 400, on the basis of the hardware physical link rate and the programmed physical link rate stored in the NVRAM 440 of the discover target expander 400 (first device), as well as the hardware physical link rate and the programmed physical link rate (already acquired in S7170) identified by use of the specification ID in the SAS address of the expander 400 (second device) directly coupled to the discover target expander 400, and determines whether or not the expected communication rate matches with the negotiated link rate (S7190).

As a result, if these rates match with each other, the controller 330 advances to “Y” and terminates the process in S6030.

In contrast, if the rates do not match, the controller 330 advances to “N” from S7190 and increments by one the count value of link rate failure errors in the discover error management table 650 (S7200). If the count value does not exceed the threshold (S7210), the controller 330 executes the predetermined error recovery process (S7220) and re-executes the link-up process.

If the count value exceeds the threshold, the controller 330 sets invalid (S7230) and terminates the process in S6030.

On the other hand, when the discover target expander 400 supports the discover list request in S6020 in FIG. 35, the controller 330 advances to “Y” from 6020.

In this case, the controller 330 firstly acquires the hardware physical link rate and the programmed physical link rate set for the expander 400.

The controller 330 can acquire the hardware physical link rate and the programmed physical link rate by referring to the SAS address identification information management table 630 using the specification ID written in the SAS address of the expander 400.

Then, the controller 330 compares the hardware physical link rate and the programmed physical link rate with each other to determine whether or not the programmed physical link rate is equal to the hardware physical link rate (S6040). When the hardware physical link rate and the programmed physical link rate have different values, the process advances to “N.”

Thereafter, the controller 330 updates the value of the programmed physical link rate stored in the NVRAM 440 in the expander 400 to the same value as the hardware physical link rate (S6050).

The controller 330 updates the specification ID in the SAS address stored in the NVRAM 440 in the expander 400 to a specification ID corresponding to the updated programmed physical link rate and the hardware physical link rate (S6060).

After that, the controller 330 executes the link-up process again (S6070) to use the expander 400 with the new specification.

Updating the programmed physical link rate as described above enables the expander 400 to be used at a higher communication rate, than the suppressed communication rate used until then.

For example, suppose a case where, when the expander 400 is used at a suppressed communication rate because the communication rate determined by the SAS standard is lower than the communication rate originally achievable by the expander 400, a new SAS standard is developed and defines a higher communication rate. In this case, the expander 400 used until then at the suppressed communication rate can be used continuously at a higher communication rate without the need to exchange, only if the setting information thereof is updated.

Next, the controller 330 executes the discover process on the expander 400 by using the discover list request defined in the SAS2 standard (S6080).

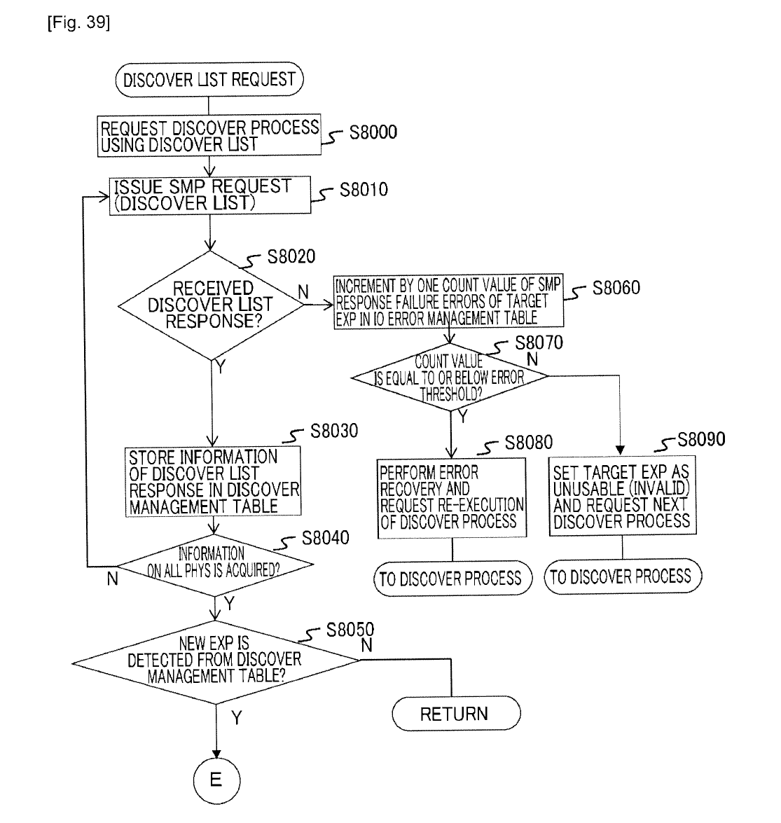

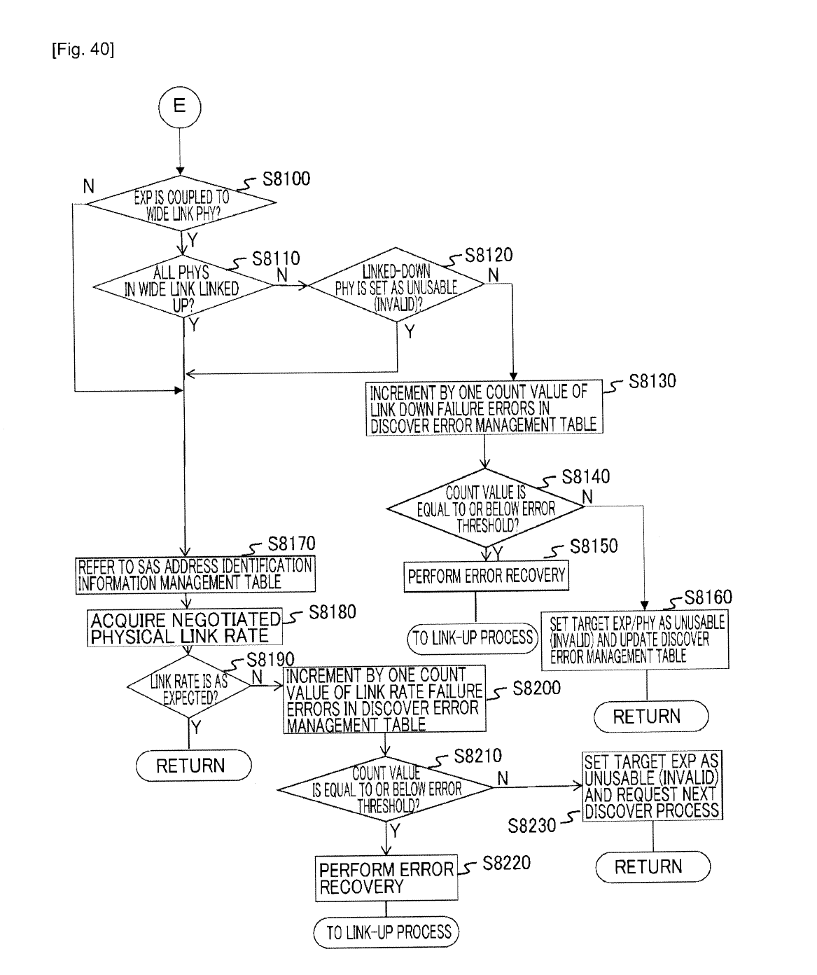

Hereinafter, by referring to FIGS. 39 and 40, description will be provided for the process in which the controller 330 executes the discover process on the expander 400 by using the discover list request defined in the SAS2 standard

First, the controller 330 instructs the SAS controller 370 to execute the discover process using the discover list request (S8000).

In response to this, the SAS controller 370 transmits the SMP request of the discover list request to the discover target expander 400 (S8010).

When the SAS controller 370 does not receive the discover list response from the expander 400 within a predetermined time period, the controller 330 advances to “N” from S8020 and increments by one the SMP response error count value in the IO error management table 670 (S8060).

If the count value does not exceed the threshold (S8070), the controller 330 executes the predetermined error recovery process (S8080) and re-executes the discover process.

If the count value exceeds the threshold, the controller 330 sets the expander 400 as invalid in the discover error management table 650 and executes the next discover process (S8090).

On the other hand, when the SAS controller 370 receives the discover list response from the expander 400 within the predetermined time period, the controller 330 advances to “Y” and stores the content of the discover list response in the discover management table 610 (S8030).

Then, the controller 330 determines whether or not the discover process is completed for all the PHYs 411 in the expander 400 (S8040). If there is a pre-discover PHY 411, the controller 330 returns to S8010 and executes the discover process on the pre-discover PHY 411.

When the discover process is completed for all the PHYs 411 in the expander 400, the controller 330 determines in S8050 whether or not the newly found device in the above discover process is an expander 400 (S8050).

If the newly found device is not an expander 400, the controller advances to “N” from S8050 and terminates the process in S6080.

If the newly found device is an expander 400, the controller advances to “Y” from S8050 and determines whether or not the expander 400 is coupled to a wide link 451 (S8100).

If the expander 400 is coupled to the wide link 451, the controller 330 determines whether or not all the PHYs 411 in the wide link 451 are linked up (S8110).

If there is a PHY 411 not linked up, the controller 330 advances to “N” from S8110, and increments by one the count value of link down failure errors in the discover error management table 650 (S8130). If the count value does not exceed the threshold (S8140), the controller 330 executes the predetermined error recovery process (S8150) and re-executes the link-up process.

If the count value exceeds the threshold, the controller 330 sets invalid (s8160) and terminates the process in S6080.

In any of the cases where the expander 400 is not coupled to the wide link 451 (S8100), where all the PHYs 411 in the wide link 451 are linked up even if the expander 400 is coupled to the wide link 451 (S8110), and where any of the PHYs 411 is set as invalid even if there is a PHY 411 not being linked up (S8120), the controller 330 refers to the SAS address identification information management table 630 using the SAS address of the expander 400 (already acquired through the discover list response) (S8170) and acquires the hardware physical link rate and the programmed physical link rate of the expander 400 identified by use of the specification ID in the SAS address of the expander 400 (S8170).

Then, the controller 330 acquires the negotiated link rate stored in the memory 412 of each PHY 411 of the expander 400 after discover process (S8180).

Thereafter, the controller 330 obtains the expected communication rate between the expanders 400, on the basis of the hardware physical link rate and the programmed physical link rate stored in the NVRAM 440 of the discover target expander 400 (first device), as well as the hardware physical link rate and the programmed physical link rate (already acquired in S8170) identified by use of the specification ID in the SAS address of the expander 400 (second device) directly coupled to the discover target expander 400, and determines whether or not the expected communication rate matches the negotiated link rate (S8190).

As a result, if these rates match each other, the controller 330 advances to “Y” and terminates the process in S6080.

In contrast, if the rates do not match, the controller 330 advances to “N” from S8190 and increments by one the count value of link rate failure errors in the discover error management table 650 (S8200). If the count value does not exceed the threshold (S8210), the controller 330 executes the predetermined error recovery process (S8220) and re-executes the link-up process.

If the count value exceeds the threshold, the controller 330 sets invalid (S8230) and terminates the process in S6080.

Returning to FIG. 35, when the discover process on the expander 400 by using the discover request or the discover list request is completed as described above, the controller 330 determines whether a device coupled to an upstream-side wide link 451 of the discover target expander 400 is an expander 400 (S6090).

When the device coupled to the upstream-side wide link 451 of the discover target expander 400 is an expander 400, the process advances to “Y” from S6090 and the controller 330 sets the routing table 421 in the upstream-side expander 400.

Specifically, the controller 330 registers the SAS address of the discover target expander 400 in the routing table 421 of the upstream-side expander 400 (S6100).

Thereafter, when the controller 330 finds a new SAS address by receiving the discover response or the discover list response, the controller 330 advances to “Y” from S6110. In contrast, when no new SAS address is found, the controller 330 advances to “N” and registers the result of the discover process in the latest map storage table 620 (S6120).

When a new SAS address is found, the controller 330 acquires information (for example, a SAS version) on the device having the new SAS address by referring to the SAS address identification information management table 630 using the SAS address (S6130).

In addition, the controller 330 registers the acquired information in the discover error management table 650 (S6140), and then starts the process in S6020 and the following steps.

By iteratively executing the above process, the storage apparatus 300 can execute the discover process for all the devices in the storage apparatus 300.

<Connection Rate Determination>

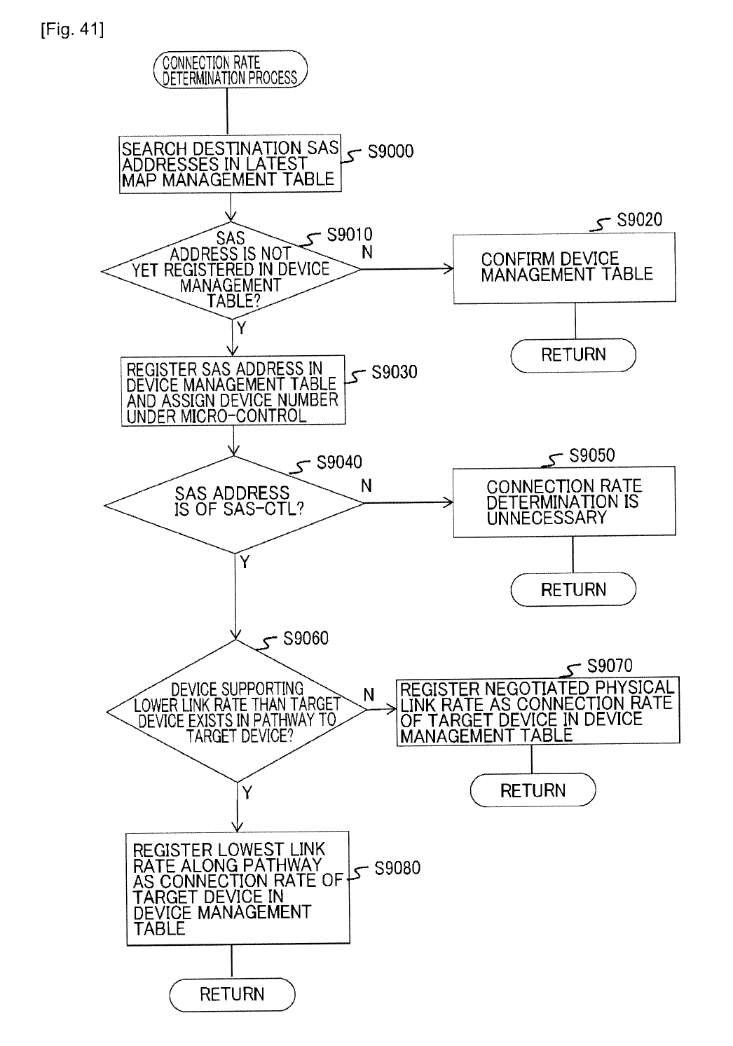

Next, by referring to a flowchart in FIG. 41, description will be provided for the process in which the controller 330 determines the connection rate for communication with each device in the storage apparatus 300. As a result of this process, the device management table shown in FIG. 45 is generated.

Firstly, the controller 330 extracts one of the SAS addresses written in a destination SAS address field by referring to the latest map storage table 620 (S9000). Then, the controller 330 determines whether or not the SAS address is a SAS address not registered yet in the device management table 640 (S9010).

If the SAS address is already registered in the device management table 640, the controller 330 advances to “N” from S9010 and confirms the information on the SAS address registered in the device management table 640 (S9020). After that, the controller 330 extracts the next SAS address from the latest map storage table 620 and again performs the process from S9000.

On the other hand, when the SAS address is not registered yet in the device management table 640, the controller 330 registers the yet-to-be registered SAS address in the device management table 640. At this time, the controller 330 assigns a device number to the device having the SAS address (S9030). The device number makes the device uniquely identifiable in the storage apparatus 300, and is registered in association with the SAS address of the device. The device number includes a unit number, a device number, an HDU number, and an ENC number, for example.

Then, the controller 330 determines whether or not the SAS address is other than the SAS address of the SAS controller 370 (S9040). If the SAS address is the SAS address of the SAS controller 370, the process advances to “N” and the controller 330 determines that no connection rate setting is necessary (S9050). After that, the controller 330 extracts the next SAS address from the latest map storage table 620 and again performs the process from S9000.

On the other hand, if the SAS address is other than the SAS address of the SAS controller 370, the controller 330 acquires the maximum communication rates of devices along a pathway from the SAS controller 370 to the device (target device) identified by use of the SAS address, and compares the lowest value among the thus acquired maximum communication rates with the maximum communication rate of the target device (S9060).

As a result, if the maximum communication rate of the target device is higher than the lowest value, the controller 330 advances to “Y” from S9060 and registers the lowest value as the connection link rate of the target device in the device management table 640 (S9080).

On the other hand, if the maximum communication rate of the target device is lower than or equal to the lowest value, the controller 330 advances to “N” from S9060 and registers the negotiated link rate of the target device in the device management table 640 (S9070). After that, the controller 330 extracts the next SAS address from the latest map storage table 620 and again performs the process from S9000.

Executing the above process allows the controller 330 to set the connection rate of each device in the storage apparatus 300.

<Setup of RAID Group>

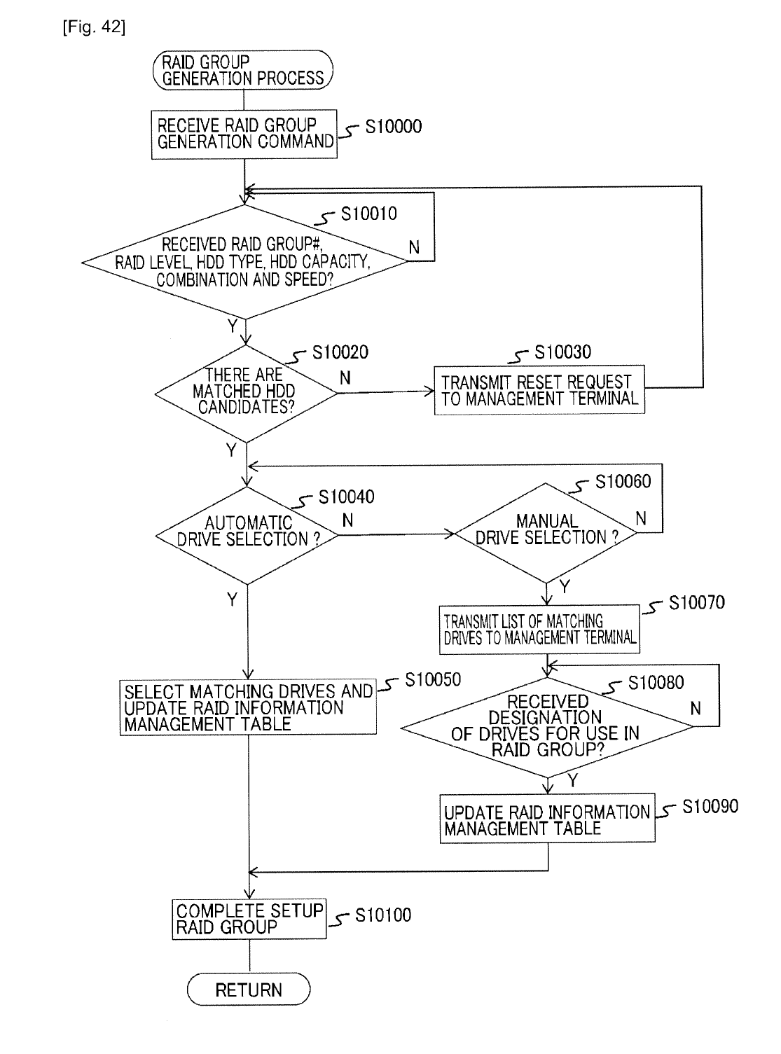

Next, with reference to a flowchart in FIG. 42, description will be provided for process in which the controller 330 sets up the RAID group 340.

First, the controller 330 receives a command from the management terminal 200 to generate the RAID group 340 (S10000). In response to this, the controller 330 determines whether or not a RAID group number, a RAID level (for example, RAID 5), a HDD type (for example, SAS drive), a HDD capacity (for example, 2 TB), a combination (for example, a 4D+1P configuration), and a speed (a connection rate) have been received from the management terminal 200 (S10010).

When receiving these information, the controller 330 determines whether or not there are storage drives 350 matching the information by referring to the device management table 640 (S10020). If there are no matching storage drives 350, the controller 330 transmits a reset request and information indicating the unavailability to the management terminal 200 (S10030).

On the other hand, if there are matching storage drives 350,

the controller 330 determines whether the storage drives to constitute the RAID group 340 are to be selected by an operator manually (manual selection) or by the controller 330 (automatic selection) (S10040). The selection method, i.e., the automatic selection or the manual selection, is written in the command to generate the RAID group 340, which is transmitted from the management terminal 200 in S10000.

In the case of automatic selection (S10040), the controller 330 selects the storage drives 350 to constitute the RAID group 340 from the matching storage drives in accordance with a predetermined algorithm (S10050). Then, the controller 330 registers information on the generated RAID group 340 in the RAID information management table 660.

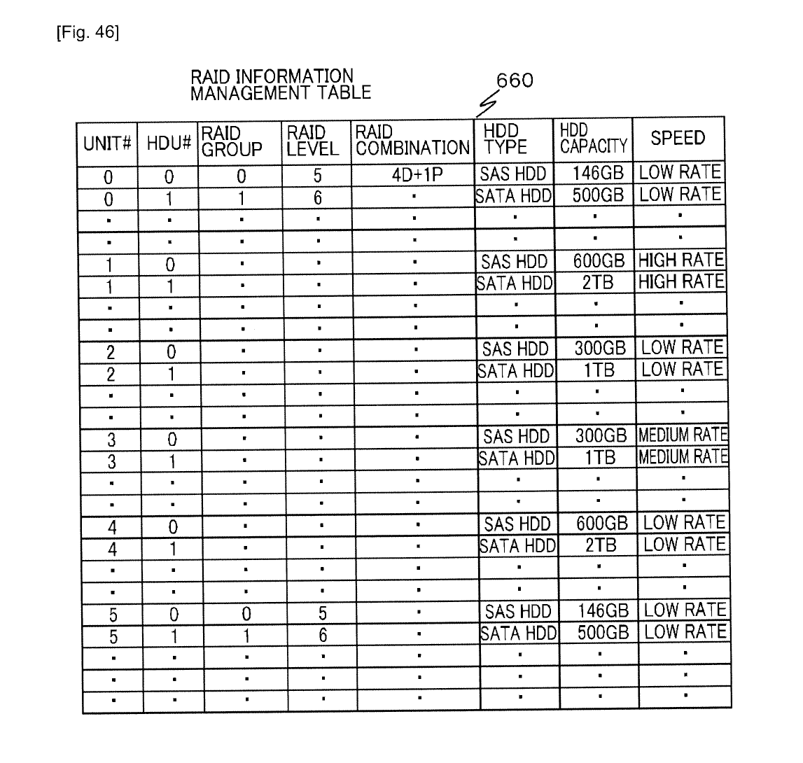

FIG. 46 shows an RAID information management table 660. The RAID information management table 660 contains RAID group 340 based information including unit numbers, HDU numbers, RAID group 340 number, RAID level, RAID group 340 configuration (combination), type of RAID group 340 constituting storage drives 350, and storage capacity and connection rate of RAID group 340 constituting storage drives 350.

On the other hand, in the case of the manual selection (S10060), the controller 330 transmits a list of matching storage drives 350 to the management terminal 200 (S10070). Then, when the operator selects the storage drives 350 (S10080), the controller 330 forms the RAID group 340 by using the selected storage drives 350.

Thereafter, the controller 330 registers the information on the generated RAID group 340 in the RAID information management table 660 (S10090).

In this way, the controller 330 generates RAID group 340 (S10100).

Hereinabove, storage apparatus 300 according to the present embodiment has been described. In the storage apparatus 300 according to the present embodiment, the communication rate between devices along a path from a controller 330 of storage apparatus 300 to a target storage drive 350 is set by speed negotiation made by the devices upon coupling to each other, and the communication rate thus set can be compared with the expected value of the communication rate determined by the maximum communication rates of these devices.

Thus, when the set connection rate is different from the expected value, the performance of the storage apparatus 300 can be improved by taking a certain measure for achieving the communication rate at an expected value.

In addition, the controller 330 is provided with the SAS address identification information table 630 in which each piece of information indicating a communication rate is stored in association with identification information of the piece of information. Meanwhile, each device internally stores the above identification information associated with a maximum communication rate of the device. In the discover process on a device at a preceding stage (on the upstream side), the above identification information of a pre-discover device at a latter stage (on the downstream side) is acquired. In this way, a communication rate error in communication between these devices can be detected before execution of the discover process on the device at the latter stage.

In addition, the device identification information of the pre-discover device at a latter stage can be acquired even with use of the discover list response in the short format. Thus, the error detection can be performed at high speed.

Moreover, assignment of an identifier to the SAS address of each expander 400 produces the following effects and thereby enables a reduction in the discover process time and early error detection in the discover process.

Firstly, this eliminates the necessity to issue a report general for acquiring various settings of each expander 400. In addition, when the discover list is used, the short format can be used and therefore an increased number of listed items are acquirable using a single SMP request.

Moreover, in the discover process on an expander 400 at the preceding stage, the type of expander 400 coupled at a latter stage can be acquired. Thus, finding that the negotiated link rate is not as expected enables an error detection to be made without execution of the discover process on the expander 400 at the latter stage.

Additionally, when an expander 400 existing along a path to a target device such as a storage drive 350 only supports a lower communication rate than the target device, the CPU 331 can set the connection rate of the target device to the lowest communication rate supported by the expander 400 along the path. In addition, the RAID group 340 can be configured by using only storage drives 350 having the same connection rate.

In addition, the storage apparatus according to this embodiment can be configured as follows.

The storage apparatus 300 includes a controller and an expander. The controller receives a data input/output request transmitted from an information apparatus communicatively coupled to the controller, and transmits an I/O request to a storage drive in response to the data input/output request. The expander is coupled to the controller via a communication path, receives the I/O request transmitted from the controller and transmits the I/O request to the storage drive. The controller includes: a controller communication rate setting unit configured to set a communication rate for the expander upon detecting that coupling to the expander via the communication path has been established, by transmitting and receiving test data to and from the expander while changing a communication rate in the transmission and reception of the test data from a predetermined rate; a controller set value storage unit configured to store a set value of the communication rate between the controller and the expander; and a controller maximum communication rate storage unit configured to store a maximum communication rate of the controller. The expander includes an expander maximum communication rate storage unit configured to store a maximum communication rate of the expander. The controller includes: a first information acquisition unit configured to send the expander a transmission request for information indicating the maximum communication rate of the expander and to receive a response including information indicating the maximum communication rate of the expander; a first expected value calculation unit configured to obtain a lower one of the maximum communication rate of the controller and the maximum communication rate of the expander as an expected value of the communication rate between the controller and the expander; a first communication rate comparison unit configured to compare the expected value of the communication rate between the controller and the expander with the set value of the communication rate between the controller and the expander; and a first comparison result storage unit configured to store the comparison result obtained by the first communication rate comparison unit.

According to such an aspect also enables the communication rate between devices along a path from the controller 330 of the storage apparatus 300 to a target storage drive 350 to be set by the speed negotiation by the devices upon coupling to each other, and the set communication rate can be compared with the expected value of the communication rate determined by the maximum communication rates of these devices.

Thus, when the set connection rate is different from the expected value, the performance of the storage apparatus 300 can be improved by taking a certain measure for achieving the communication rate at the expected value.

In addition, the controller includes a communication rate table in which each piece of information indicating a communication rate is stored in association with identification information of the piece of information. The expander includes an expander identification information storage unit configured to store expander identification information associated with the maximum communication rate of the expander; and an expander identification information transmission unit configured to transmit the expander identification information stored in the expander identification information storage device to the controller upon detecting that coupling to the controller via the communication path has been established. The controller includes an expander identification information receiving unit configured to receive the expander identification information transmitted from the expander upon detecting that the coupling to the expander via the communication path has been established; and an expander maximum communication rate identifying unit configured to identify the maximum communication rate of the expander on the basis of the piece of information indicating the communication rate stored in the communication rate table in association with the expander identification information.

As described above, the controller 330 is provided with the SAS address identification information table 630 in which each piece of information indicating a communication rate is stored in association with identification information of the piece of information. Meanwhile, each device internally stores the identification information associated with the maximum communication rate of the device. In the discover process on a device at the preceding stage (on the upstream side), the identification information of a pre-discover device at the latter stage (on the downstream side) is acquired. In this way, a communication rate error in communication between these devices can be detected before execution of the discover process on the device at the next stage.

In addition, the acquisition of the device identification information of the pre-discover device at the latter stage is enabled even with use of the discover list response in the short format. Thus, the error detection can be performed at high speed.

Moreover, the I/O request is an open address frame defined by the SAS standard and the storage drive may include a storage drive maximum communication rate storage device configured to store a maximum communication rate of the storage unit. The controller may include: a second information acquisition unit configured to send the storage drive a transmission request for information indicating the maximum communication rate of the storage drive and to receive a response including the information indicating the maximum communication rate of the storage drive; a connection rate calculation unit configured to obtain as a connection rate defined by a SAS standard a smallest value among the maximum communication rate of the controller, the maximum communication rate of the expander, and the maximum communication rate of the storage drive; and an open address frame transmission unit configured to transmit the open address frame to the storage drive with the connection rate written in the open address frame.

Assignment of an identifier to the SAS address of each expander 400 produces the following effects and thereby enables a reduction in the discover process time and early error detection in the discover process.

Firstly, this eliminates the necessity to issue a report general for acquiring various settings of each expander 400. In addition, when the discover list is used, the short format can be used and therefore an increased number of listed items are acquirable with a single SMP request.

Moreover, in the discover process on an expander 400 at the preceding stage, the type of an expander 400 coupled to the latter stage can be acquired. Thus, by finding that the negotiated link rate is not as expected, an error detection can be made without executing the discover process on the expander 400 at the latter stage.

Additionally, when an expander 400 exists along a path to a target device such as a storage drive 350 only supporting a lower communication rate than the target device, the CPU 331 can set the connection rate of the target device according to the lowest communication rate supported by the expander 400 along the path. In addition, the RAID group 340 can be configured by using only storage drives 350 having the same connection rate.

Hereinabove, preferred embodiments of the present invention have been described. However, these embodiments are for illustrating the invention, and are not intended to limit the scope of the invention to the embodiments. The present invention can be implemented in other various ways.

1. A storage apparatus comprising:
a controller that receives a data input/output request transmitted from an information apparatus communicatively coupled to the controller, and transmits an I/O request to a storage drive in response to the data input/output request; and
an expander coupled to the controller via a communication path and receives the I/O request transmitted from the controller and transmits the I/O request to the storage drive, wherein the controller includes:
a communication rate table in which each piece of information indicating a communication rate is stored in association with identification information of the piece of information;
a controller identification information storage unit that stores controller identification information associated with a maximum communication rate of the controller;
a controller communication rate setting unit that sets a communication rate for the expander upon detecting that coupling to the expander via the communication path has been established, by transmitting and receiving test data to and from the expander while changing from a predetermined rate a communication rate in the transmission and reception of the test data; and
a controller set value storage unit that stores a set value of the communication rate between the controller and the expander,
the expander includes:
an expander identification information storage unit that stores expander identification information associated with a maximum communication rate of the expander; and
an expander identification information transmission unit that transmits the expander identification information stored in the expander identification information storage unit to the controller, upon detecting that coupling to the controller via the communication path has been established, and
the controller includes:
an expander identification information receiving unit that receives the expander identification information transmitted from the expander upon detecting that the coupling to the expander via the communication path has been established;
a controller maximum communication rate identifying unit that identifies the maximum communication rate of the controller on the basis of the piece of information indicating the communication rate stored in the communication rate table in association with the controller identification information;
an expander maximum communication rate identifying unit that identifies the maximum communication rate of the expander on the basis of the piece of information indicating the communication rate stored in the communication rate table in association with the expander identification information;
a first expected value calculation unit that obtains a lower one of the maximum communication rate of the controller and the maximum communication rate of the expander as an expected value of the communication rate between the controller and the expander;
a first communication rate comparison unit that compares the expected value of the communication rate between the controller and the expander with the set value of the communication rate between the controller and the expander; and
a first comparison result storage unit that stores the comparison result obtained by the first communication rate comparison unit.

2. The storage apparatus according to claim 1, wherein the expander includes:
an expander communication rate setting unit that sets a communication rate practicable for communication with the storage drive upon detecting that coupling to the storage drive via a communication path is established, by transmitting and receiving test data to and from the storage drive while changing from a predetermined rate a communication rate in the transmission and reception of the test data; and
an expander set value storage unit that stores a set value of the communication rate between the expander and the storage drive,
the storage drive includes:
a storage drive identification information storage unit that stores storage drive identification information associated with a maximum communication rate of the storage drive; and
a storage drive identification information transmission unit that transmits the storage drive identification information stored in the storage drive identification information storage unit to the expander upon detecting that coupling to the expander via the communication path has been established,
the expander includes a storage drive identification information receiving unit that receives the storage drive identification information transmitted from the storage drive upon detecting that the coupling to the storage drive via the communication path has been established, and the controller includes:
an information acquisition unit that sends the expander a transmission request for the set value of the communication rate between the expander and the storage drive and the storage drive identification information and receives a response including the set value of the communication rate and the storage drive identification information from the expander;
a storage drive maximum communication rate identifying unit that identifies the maximum communication rate of the storage drive on the basis of the piece of information indicating a communication rate stored in the communication rate table in association with the storage drive identification information;
a second expected value calculation unit that obtains a lower one of the maximum communication rate of the expander and the maximum communication rate of the storage drive as an expected value of the communication rate between the expander and the storage drive;
a second communication rate comparison unit that compares the expected value of the communication rate between the expander and the storage drive with the set value of the communication rate between the expander and the storage drive; and
a second comparison result storage unit that stores the comparison result obtained by the second communication rate comparison unit.

3. The storage apparatus according to claim 2, wherein
the I/O request is an open address frame defined by a SAS standard,
the controller includes:
a connection rate calculation unit that obtains, as a connection rate defined by the SAS standard, the lowest value among the maximum communication rate of the controller, the maximum communication rate of the expander and the maximum communication rate of the storage drive; and
an open address frame transmission unit that transmits the open address frame having written therein the connection rate to the storage drive.

4. The storage apparatus according to claim 3, wherein
the expander has a plurality of the storage drives coupled thereto via communication paths, respectively,
the controller includes
a RAID group configuring unit that configures a RAID group with the storage drives; and
a connection rate storage unit that stores the connection rate obtained for each of the storage drives, in association with the storage drive, and the RAID group configuring unit configures the RAID group with the storage drives having a same connection rate.

5. The storage apparatus according to claim 1, wherein
the piece of information indicating the communication rate stored in the communication rate table is a piece of information indicating a maximum communication rate.

6. The storage apparatus according to claim 1, wherein
the piece of information indicating the communication rate stored in the communication rate table includes a hardware maximum value that is a maximum communication rate defined on the basis of hardware performance, and a software maximum value defined as a maximum communication rate in actual operation,
the controller maximum communication rate identifying unit identifies, as the maximum communication rate of the controller, a smaller one of the hardware maximum value and the software maximum value stored in the communication rate table in association with the controller identification information, and
the expander maximum communication rate identifying unit identifies, as the maximum communication rate of the expander, a smaller one of the hardware maximum value and the software maximum value stored in the communication rate table in association with the expander identification information.

7. The storage apparatus according to claim 2, wherein
the piece of information indicating the communication rate stored in the communication rate table includes a hardware maximum value that is a maximum communication rate defined on the basis of hardware performance, and a software maximum value defined as a maximum communication rate in actual operation,
the expander includes:
a hardware maximum communication rate storage unit that stores a hardware maximum value of the expander; and
a software maximum communication rate storage unit that stores a software maximum value of the expander,
the controller includes a maximum value comparison unit that compares the hardware maximum value and the software maximum value stored in the communication rate table in association with expander identification information received from the expander by the expander identification information receiving unit;
a maximum value updating unit that updates the software maximum value stored in the software maximum communication rate storage unit included in the expander to the same value as the hardware maximum value when the software maximum value is smaller than the hardware maximum value; and
an identification information updating unit that updates the expander identification information stored in the expander identification information storage unit included in the expander to new identification information determined by a combination of the hardware maximum value and the updated software maximum value.

8. The storage apparatus according to claim 1, wherein
the expander identification information storage unit is a memory that stores a SAS address assigned to the expander in accordance with the SAS standard, and
the expander identification information is written in the SAS address stored in the expander identification information storage unit.

9. The storage apparatus according to claim 2, wherein
the response received from the expander by the information acquisition unit is a discover list response in a short format defined by a SAS standard.

10. The storage apparatus according to claim 1, wherein
the controller includes a comparison result transmission unit that transmits the result stored in the first comparison result storage unit to a management terminal communicatively coupled to the controller.

11. A method of controlling a storage apparatus including
a controller that receives a data input/output request transmitted from an information apparatus communicatively coupled to the controller, and transmits an I/O request to a storage drive in response to the data input/output request; and
an expander coupled to the controller via a communication path and receives the I/O request transmitted from the controller and transmits the I/O request to the storage drive, the controller including
a communication rate table in which each piece of information indicating a communication rate is stored in association with identification information of the piece of information; and
a controller identification information storage unit that stores controller identification information associated with a maximum communication rate of the controller,
the expander including an expander identification information storage unit that stores expander identification information associated with a maximum communication rate of the expander,
the method comprising the steps of:
setting, by the controller, a communication rate with the expander upon detecting that coupling to the expander via the communication path has been established, by transmitting and receiving test data to and from the expander while changing from a predetermined rate a communication rate in the transmission and reception of the test data;
storing, by the controller, a set value of the communication rate between the controller and the expander;
transmitting, by the expander, the expander identification information stored in the expander identification information storage unit to the controller upon detecting that coupling to the controller via the communication path has been established;
receiving, by the controller, the expander identification information transmitted from the expander upon detecting that the coupling to the expander via the communication path has been established;
identifying, by the controller, the maximum communication rate of the controller on the basis of the information indicating the communication rate stored in the communication rate table in association with the controller identification information;
identifying, by the controller, the maximum communication rate of the expander on the basis of the piece of information indicating the communication rate stored in the communication rate table in association with the expander identification information;
obtaining, by the controller, a lower one of the maximum communication rate of the controller and the maximum communication rate of the expander, as an expected value of the communication rate between the controller and the expander; and
comparing, by the controller, the expected value of the communication rate between the controller and the expander with the set value of the communication rate between the controller and the expander and storing the comparison result.
